(19) United States
(12) Patent Application Publication
(10) Pub. No.: US 2015/0015083 A1
(43) Pub. Date: Jan. 15, 2015

(54) POWER RECEIVING APPARATUS, POWER SUPPLYING APPARATUS, AND COMMUNICATION APPARATUS

(71) Applicants: Koichiro Nakase, Tokyo (JP); Tsuneo Tsukagoshi, Tokyo (JP); Naoki Kobayashi, Tokyo (JP); Hiroshi Fukuda, Tokyo (JP)

(72) Inventors: Koichiro Nakase, Tokyo (JP); Tsuneo Tsukagoshi, Tokyo (JP); Naoki Kobayashi, Tokyo (JP); Hiroshi Fukuda, Tokyo (JP)

(73) Assignee: NEC CORPORATION, Tokyo (JP)

(21) Appl. No.: 14/375,208

(22) PCT Filed: Nov. 26, 2012
(86) PCT No.: PCT/JP2012/007567

§ 371 Date: Jul. 29, 2014

(30) Foreign Application Priority Data
Feb. 24, 2012 (JP) 2012-038181

(51) Int. Cl. H02J 17/00

(52) U.S. Cl. CPC H02J 17/00
USPC 307/104

(57) ABSTRACT

An object is to provide a compact interface apparatus capable of receiving electric power, supplying electric power, or/and performing communication on a communication sheet while reducing the influence of a standing wave. A power receiving apparatus (100) that receives electric power from a electromagnetic-wave propagation sheet (10) includes a first conductor section (110) and a second conductor section (120) that couple with an electromagnetic wave propagating through the electromagnetic-wave propagation sheet (10) and thereby receive electric power. The first and second conductor sections (110 and 120) are arranged so that the interval in a first direction between one end of the first conductor section (110) and one end of the second conductor section (120) in the first direction is no less than 2λ/14 and no greater than 5λ/14, where λ is the effective wavelength of the electromagnetic wave propagating through the electromagnetic-wave propagation sheet (10).

### TECHNICAL FIELD

The present invention relates to a power receiving apparatus, a power supplying apparatus, and a communication apparatus, and in particular to a coupler-type power receiving apparatus that receives electric power by coupling with an electromagnetic wave that seeps from a two-dimensional electromagnetic-wave propagation sheet, a coupler-type power supplying apparatus that supplies electric power to the electromagnetic-wave propagation sheet, and a coupler-type communication apparatus that performs communication by using the electromagnetic-wave propagation sheet.

### BACKGROUND ART

The development of an electromagnetic-wave propagation sheet (hereinafter also referred to as “communication sheet”) that is formed by disposing a sheet-like conductor and a meshed sheet-like conductor on respective surfaces (i.e., both surfaces) of a two-dimensional (hereinafter expressed as “2D”) dielectric substrate and lets an electromagnetic wave propagate therethrough in a state where a part of the electromagnetic wave leaks from the meshed conductor has been underway (for example, Patent Literature 1).

Patent Literature 2 discloses an interface apparatus that transmits/receives a signal by using the above-described communication sheet. This interface apparatus includes an inner conductor section disposed near the meshed conductor of the communication sheet in a noncontact state, and an outer conductor section covering the inner conductor section. The interface apparatus has a configuration in which a path conductor section is connected to the inner conductor section, and the path conductor section passes through an opening formed in the outer conductor section in a noncontact state and is connected to a coaxial cable or a signal transmitting/receiving circuit. Signal transmission can be performed by disposing this interface apparatus near the communication sheet, so that the usability for users is improved.

Further, Patent Literature 3 discloses a power supply apparatus that supplies electric power to a load(s) more efficiently than the above-described communication sheet. This power supply apparatus includes a plurality of electrodes arranged in an array and a plurality of rectifier circuits that rectify an electromagnetic wave(s) received by two electrodes, in which each electrode is used in common as an input of the plurality of rectifier circuits, thus making it possible to efficiently take out the energy of the electromagnetic wave.

### CITATION LIST

### Patent Literature

Patent Literature 1: International Patent Publication No. WO2007/032049
Patent Literature 2: International Patent Publication No. WO2007/032339
Patent Literature 3: Japanese Unexamined Patent Application Publication No. 2008-295176

### SUMMARY OF INVENTION

### Technical Problem

As for the above-described communication sheet disclosed in Patent Literature 1, one of the advantages over the other systems is considered to be the fact that a system that performs communication or/and supplies electric power through an interface apparatus in any place on the two-dimensionally spreading communication sheet can be constructed.

However, in the above-described communication sheet, when an electromagnetic wave is actually positioned in an interval area between the sheet-like conductor and the mesh sheet-like conductor and the electromagnetic wave is propagated by changing the voltages of these two conductors, a standing wave occurs.

Note that antinodes and nodes of the standing wave are distributed at each quarter wavelength in the seepage area in which the electromagnetic wave seeps out from the mesh sheet-like conductor. Therefore, there are places where the electromagnetic wave cannot be efficiently obtained even when the interface apparatus disclosed in Patent Literature 2 is disposed. Note that the positions of antinodes or nodes of a standing wave in an electric field are different from those in a magnetic field by a quarter wavelength. However, for the sake of convenience, the nodes of a standing wave in this example and in the following explanation indicate the places where the electric field is minimized.

Therefore, when an electromagnetic wave is obtained by disposing the interface apparatus disclosed in Patent Literature 2 near a communication sheet, the output power (received power) of the interface apparatus pulsates depending on the position of the interface apparatus on the communication sheet.

This means that there is positional selectivity in the 2D communication sheet, meaning that the advantage of the system using this communication sheet is significantly impaired.

Note that in the power supply apparatus disclosed in Patent Literature 3, a plurality of electrodes are arranged in an array on the same plane. Therefore, even if there is a node of the standing wave below one of the array electrodes, electromagnetic-wave energy could be obtained from other array electrodes. Accordingly, it is expected that the power supply to the load(s) can be stabilized.

However, in the power supply apparatus disclosed in Patent Literature 3, a plurality of electrodes are arranged in a 2D array (in a matrix pattern) to improve the power supply efficiency without giving any consideration to the influence by the standing wave occurring in the communication sheet. Therefore, there is a problem that the apparatus increases in planar size.

Accordingly, when this power supply apparatus is incorporated into a compact mobile terminal to perform communication, the occupation ratio of the power supply apparatus in the mobile terminal increases, thus causing another problem that the essential usefulness and usability of the mobile terminal are impaired.

The present invention has been made in view of the above-described problems and an object thereof is to provide a compact interface apparatus (power receiving apparatus, power supplying apparatus, or/and communication apparatus) capable of stably receiving electric power, supplying electric power, or/and performing communication on a communication sheet.

### Solution to Problem

A power receiving apparatus according to an aspect of the present invention is a power receiving apparatus that receives electric power from a two-dimensionally spreading electromagnetic-wave propagation sheet, including: a first conductor section that couples with an electromagnetic wave propagating through the electromagnetic-wave propagation sheet and thereby receives electric power; a second conductor section that couples with an electromagnetic wave propagating through the electromagnetic-wave propagation sheet and thereby receives electric power; a ground conductor section disposed in an opposed state to the first and second conductor sections, the ground conductor section being connected to a ground potential; and a power combining section that combines electric power received from the first conductor section with electric power received by the second conductor section, in which the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

Further, a power supplying apparatus according to an aspect of the present invention is a power supplying apparatus that feeds electromagnetic wave to a two-dimensionally spreading electromagnetic-wave propagation sheet disposed near the power supplying apparatus, including: a first conductor section that generates an electromagnetic wave and feeds the generated electromagnetic wave to the electromagnetic-wave propagation sheet; a second conductor section that generates an electromagnetic wave and feeds the generated electromagnetic wave to the electromagnetic-wave propagation sheet; a ground conductor section disposed in an opposed state to the first and second conductor sections, the ground conductor section being connected to a ground potential; and a power supply section that supplies electric power used to generate the electromagnetic waves in the first and second conductor sections, in which the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave fed to the electromagnetic-wave propagation sheet, the effective wavelength being an effective wavelength within the electromagnetic-wave propagation sheet.

Further, a communication apparatus according to an aspect of the present invention is a communication apparatus that performs communication through a two-dimensionally spreading electromagnetic-wave propagation sheet, including: a first conductor section that obtains a modulated signal by receiving an electromagnetic wave propagating through the electromagnetic-wave propagation sheet; a second conductor section that obtains a modulated signal by receiving an electromagnetic wave propagating through the electromagnetic-wave propagation sheet; a ground conductor section disposed in an opposed state to the first and second conductor sections, the ground conductor section being connected to a ground potential; a combining section that combines the modulated signal obtained by the first conductor section with the modulated signal obtained by the second conductor section and thereby obtains a combined modulated signal, and a demodulation section that demodulates the combined modulated signal obtained by the combining section, in which the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

### Advantageous Effects of Invention

According to the present invention, it is possible to provide a compact interface apparatus (power receiving apparatus, power supplying apparatus, or/and communication apparatus) capable of stably receiving electric power, supplying electric power, or/and performing communication on a communication sheet.

### BRIEF DESCRIPTION OF DRAWINGS

FIG. 1 shows an overall configuration of a communication system according to the present invention;

FIG. 2 is a cross section taken along a line II-II, i.e., along an electromagnetic wave propagation direction in a communication sheet according to the present invention;

FIG. 3 is a bottom view of an interface apparatus (power receiving apparatus) according to a first exemplary embodiment;

FIG. 4A is a cross section taken along a line IVA-IVA of the interface apparatus (power receiving apparatus) according to the first exemplary embodiment;

FIG. 4B is a cross section taken along a line IVB-IVB of the interface apparatus (power receiving apparatus) according to the first exemplary embodiment;

FIG. 5 is a block diagram showing a configuration of a power receiving section of an interface apparatus (power receiving apparatus) according to the first exemplary embodiment;

FIG. 6 is a block diagram showing another configuration of a power receiving section of an interface apparatus (power receiving apparatus) according to the first exemplary embodiment;

FIG. 7 is a graph showing combined received power when a distance between an open end of a first conductor section and an open end of a second conductor section of a power receiving apparatus according to the first exemplary embodiment is changed;

FIG. 8A schematically shows an electric-field distribution of an electromagnetic wave that couples with a first conductor section of a power receiving apparatus according to the first exemplary embodiment and an electromagnetic wave that couples with a second conductor section in a communication sheet in a case where the positions of the open ends of the first conductor section coincide with the positions of antinodes of a standing wave;

FIG. 8B schematically shows an electric-field distribution of an electromagnetic wave that couples with a first conductor section of a power receiving apparatus according to the first exemplary embodiment and an electromagnetic wave that couples with a second conductor section in a communication sheet in a case where the positions of the open ends of the first conductor section coincide with the positions of nodes of a standing wave;

FIG. 9 is a bottom view of an interface apparatus (power receiving apparatus) according to a second exemplary embodiment;

FIG. 10A is a cross section taken along a line XA-XA of the interface apparatus (power receiving apparatus) according to the second exemplary embodiment;

FIG. 10B is a cross section taken along a line XB-XB of the interface apparatus (power receiving apparatus) according to the second exemplary embodiment;

FIG. 11A schematically shows an electric-field distribution of an electromagnetic wave that couples with a first conductor section of a power receiving apparatus according to the second exemplary embodiment and an electromagnetic wave that couples with a second conductor section in a communication sheet in a case where the positions of the open ends of the first conductor section coincide with the positions of antinodes of a standing wave;

FIG. 11B schematically shows an electric-field distribution of an electromagnetic wave that couples with a first conductor section of a power receiving apparatus according to the second exemplary embodiment and an electromagnetic wave that couples with a second conductor section in a communication sheet in a case where the positions of the open ends of the first conductor section coincide with the positions of nodes of a standing wave;

FIG. 12 is a graph showing received power from a first conductor section, received power from a second conductor section, and combined received power when a position on a communication sheet where a power receiving section is placed is changed in an electromagnetic-wave traveling direction;

FIG. 13 is a bottom view of an interface apparatus (power receiving apparatus) according to a modified example of the second exemplary embodiment;

FIG. 14A is a cross section taken along a line XIVA-XIVA of the interface apparatus (power receiving apparatus) according to the modified example of the second exemplary embodiment;

FIG. 14B is a cross section taken along a line XIVB-XIVB of the interface apparatus (power receiving apparatus) according to the modified example of the second exemplary embodiment;

FIG. 15A is a figure for explaining a relation of a second conductor section in an interface apparatus according to the second exemplary embodiment;

FIG. 15B is a figure for explaining a relation of a second conductor section in an interface apparatus according to a modified example of the second exemplary embodiment;

FIG. 16 is a bottom view of an interface apparatus (power receiving apparatus) according to a third exemplary embodiment;

FIG. 17A is a cross section taken along a line XVIIA-XVIIA of the interface apparatus (power receiving apparatus) according to the third exemplary embodiment;

FIG. 17B is a cross section taken along a line XVIIB-XVIIB of the interface apparatus (power receiving apparatus) according to the third exemplary embodiment;

FIG. 18 is a bottom view of an interface apparatus (power receiving apparatus) according to a modified example of the third exemplary embodiment;

FIG. 19 is a bottom view of an interface apparatus (power receiving apparatus) according to a modified example of the third exemplary embodiment;

FIG. 20 is a bottom view of an interface apparatus (power receiving apparatus) according to a modified example of the third exemplary embodiment;

FIG. 21 is a block diagram showing a configuration of a power supplying section of an interface apparatus (power supplying apparatus) according to the present invention; and

FIG. 22 is a block diagram showing a configuration of a communication section of an interface apparatus (communication apparatus) according to the present invention.

### DESCRIPTION OF EMBODIMENTS

Exemplary embodiments according to the present invention are explained hereinafter with reference to the drawings. In the following explanation, preferable exemplary embodiments according to the present invention are shown. However, the scope of the present invention is not limited to the exemplary embodiments shown below. In the following explanation, the same symbols are assigned to substantially similar components/structures.

### First Exemplary Embodiment

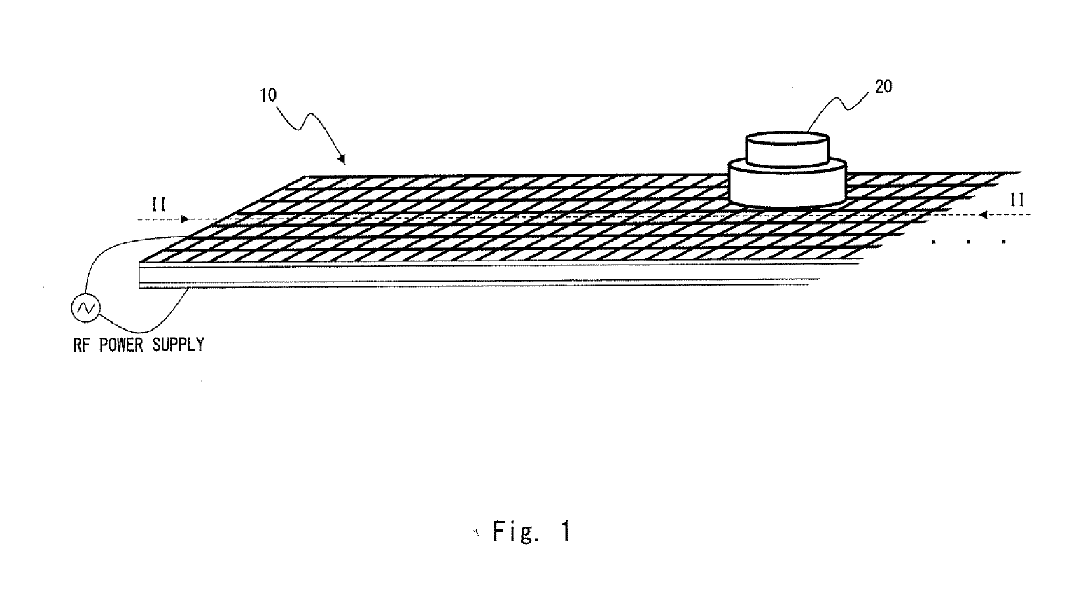

A first exemplary embodiment according to the present invention is explained hereinafter with reference to the drawings. FIG. 1 is a schematic diagram of an overall configuration of a communication system according to a first exemplary embodiment. This communication system includes a communication sheet 10 and an interface apparatus 20.

### <Regarding Configuration of Communication Sheet>

Firstly, a configuration of the communication sheet 10 is explained. Since the communication sheet 10 is a device that propagates an electromagnetic wave, it is also referred to as an “electromagnetic-wave propagation device”, “electromagnetic-wave transmission device”, “electromagnetic-wave transmission medium”, “electromagnetic-wave transmission sheet”, and so on.

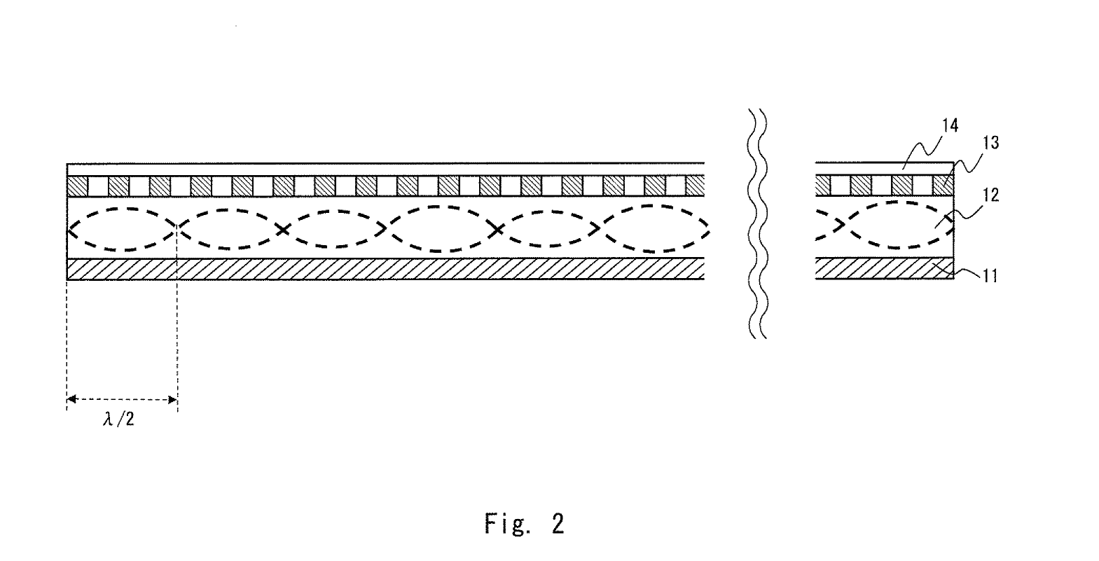

FIG. 2 is a cross section of the communication sheet 10 taken along the line II-II in FIG. 1. The communication sheet 10 includes a sheet-like conductor section 11, which is a sheet-like conductor, a dielectric section 12, which is a sheet-like dielectric, a meshed conductor section 13, which is a meshed conductor, and an insulator section 14, which is a sheet-like insulator.

Note that the term “sheet-like” means a state of an object that two-dimensionally spreads as a plane and has a slight thickness. Examples of “sheet-like” include cloth-like, paper-like, foil-like, plate-like, membrane-like, film-like, and meshed.

Further, the term “meshed” means a regularly meshed state, or a state of a plate in which a plurality of regularly-shaped or irregularly-shaped slits or openings are formed. Examples of “meshed” includes various patterns, such as the so-called meshed pattern having a pattern of openings, including a lattice pattern, a hexagonal pattern, a diamond pattern, a circular pattern, and a triangle pattern, and so on.

The sheet-like conductor section 11 and the meshed conductor section 13 are arranged roughly in parallel with each other, and an electromagnetic wave(s) propagates in the interval area between the sheet-like conductor section 11 and the meshed conductor section 13.

In this example, since the sheet-like conductor section 11 and the meshed conductor section 13 are formed on respective surfaces (i.e., both surfaces) of the sheet-like dielectric section 12, an electromagnetic wave(s) propagates inside the dielectric section 12.

The dielectric section 12 is a layer that serves as a substrate and its material is selected according to the purpose or the like of the communication sheet. Examples of the material for the dielectric section 12 include resins, rubber, foam material, and gel material. Alternatively, atmospheric air can be used as the dielectric section 12.

The meshed conductor section 13 is a conductor in which square openings are formed in a regular pattern and hence a lattice meshed pattern is formed. An electromagnetic wave called an “evanescent wave” seeps out from this meshed conductor section 13 and a seepage area of the electromagnetic wave is thereby formed above the meshed conductor section 13.

The unit of repetition of the mesh (mesh cycle) is set to a sufficiently smaller value than the effective wavelength λ of the electromagnetic wave so that the electromagnetic wave is efficiently confined in the interval area. Note that the “effective wavelength” is the wavelength of an electromagnetic wave when the electromagnetic wave is propagating through an electromagnetic-wave propagation sheet. Since the wavelength is shortened when the electromagnetic wave is propagating through an electromagnetic-wave propagation sheet according to the shape of the electromagnetic-wave propagation sheet (such as the mesh interval), the dielectric constant of the material, and so on, the wavelength in the electromagnetic-wave propagation sheet is shorter than that in a vacuum.

As an example, when an electromagnetic wave having a frequency band of 900 MHz is used for communication, its wavelength λ0 in a free space is about 33.3 cm. In this case, since the effective dielectric constant is taken into account, the effective wavelength λ of the electromagnetic wave propagating through the dielectric section 12 is shorter than the wavelength λ0.

In order to efficiently confine an electromagnetic wave and thereby enable communication to be performed in a large area, the mesh cycle of the meshed conductor section 13 is preferably set to a value equal to or less than 1/10 of the effective wavelength λ. A seeping electromagnetic wave is exponentially attenuated according to the distance from the meshed conductor section 13, and a seepage area having a height roughly equal to that the repetition unit of the mesh is formed.

The sheet-like conductor section 11 and the meshed conductor section 13 are short-circuited at the sheet end, thus preventing the electromagnetic wave from leaking from the side of the communication sheet 10 to the outside.

The sheet-like insulating section 14 is a protection film made of an insulator that is disposed to electrically isolate the interface apparatus 20 from the meshed conductor section 13 of the communication sheet 10.

As described above, the sheet-like layers including the sheet-like conductor section 11, the dielectric section 12, the meshed conductor section 13, and the insulator section 14 are stacked in this listed order so as to form the communication sheet 10.

In general, an apparatus that feeds an electromagnetic wave to the communication sheet 10 is attached at the longitudinal-direction end of the communication sheet 10, so that communication or/and the supply of electric power is performed between that the attached apparatus and the interface apparatus 20 placed above the communication sheet 10.

The electromagnetic wave supplied from the electromagnetic-wave supplying apparatus (RF power supply) attached at the longitudinal-direction end of the communication sheet 10 propagates in the longitudinal direction of the communication sheet 10 and is reflected at the opposite longitudinal-direction end. This progressing wave and reflected wave produces a standing wave in the communication sheet 10 and nodes of the standing wave appear at a cycle equivalent to the half-wavelength of the effective wavelength λ. Dotted lines in FIG. 2 schematically represent the state of this standing wave.

Therefore, when a conventional proximity coupler having a single antennal element that is originally placed in a place corresponding to a node of the standing wave is moved in the longitudinal direction of the communication sheet 10, which is the traveling direction of the electromagnetic wave, the output power (received power) from this proximity coupler pulsates and a minimum value appears at each λ/2 distance. Further, when an electromagnetic wave is supplied to the communication sheet 10 by using a proximity coupler, the supplied power of the electromagnetic wave pulsates as the proximity coupler is moved as described above because the impedance is smaller in places corresponding to nodes of the standing wave (where the electric field is minimized) than that in other places.

<Regarding Configuration of Interface Apparatus>

Next, a configuration of the interface apparatus 20 according to the present invention is explained. The interface apparatus 20 is a proximity coupler that is placed on the communication sheet 10 for use, and transmits/receives an electromagnetic wave to/from the communication sheet 10.

A first exemplary embodiment is explained on the assumption that the interface apparatus 20 is, in particular, a power receiving apparatus that receives an electromagnetic wave from the communication sheet 10.

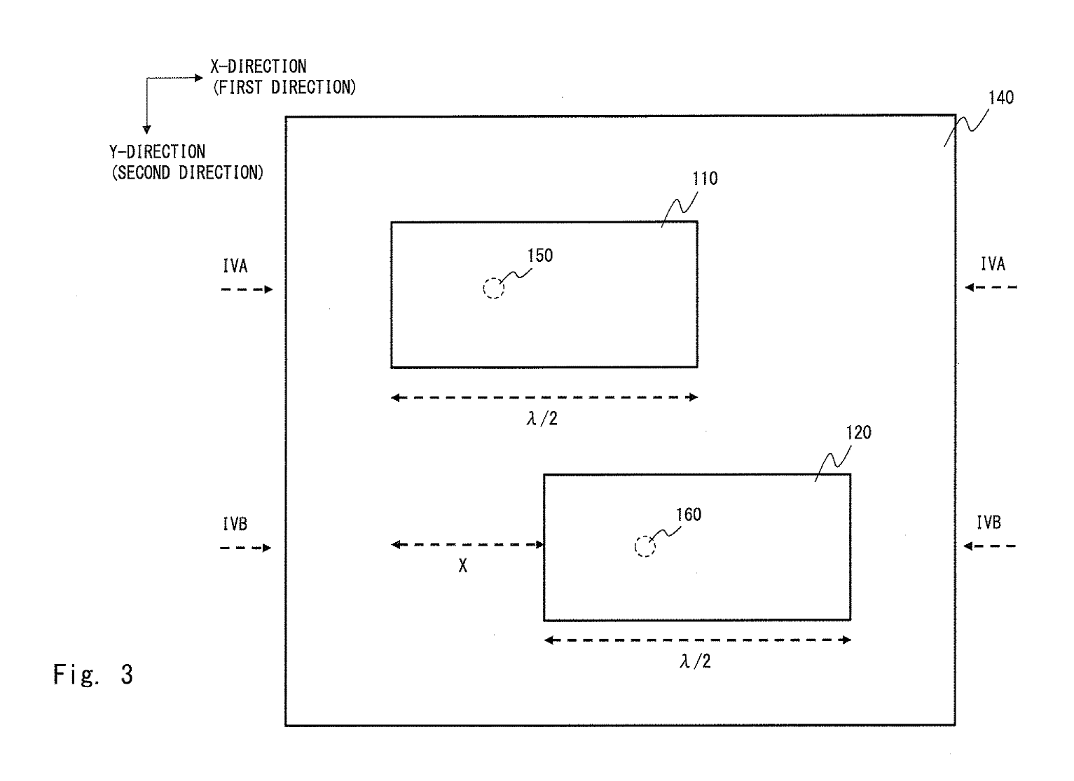

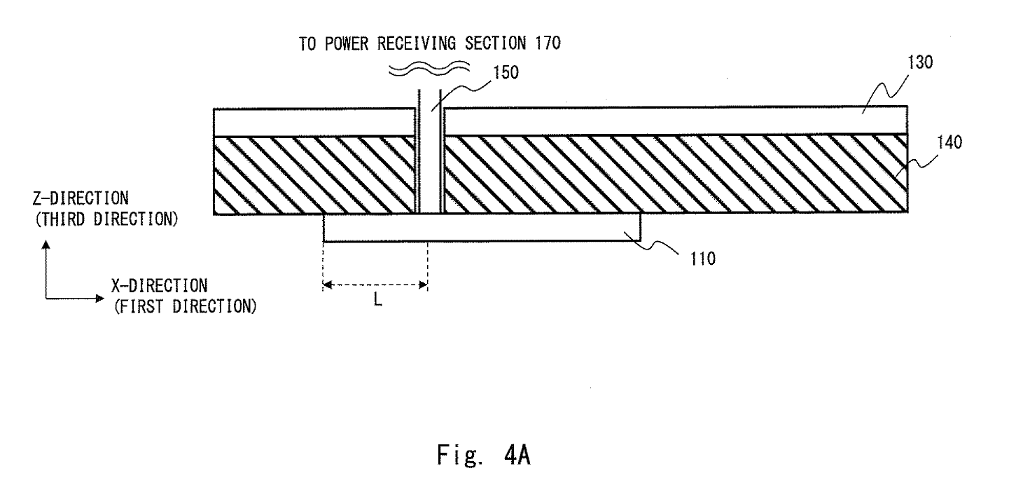

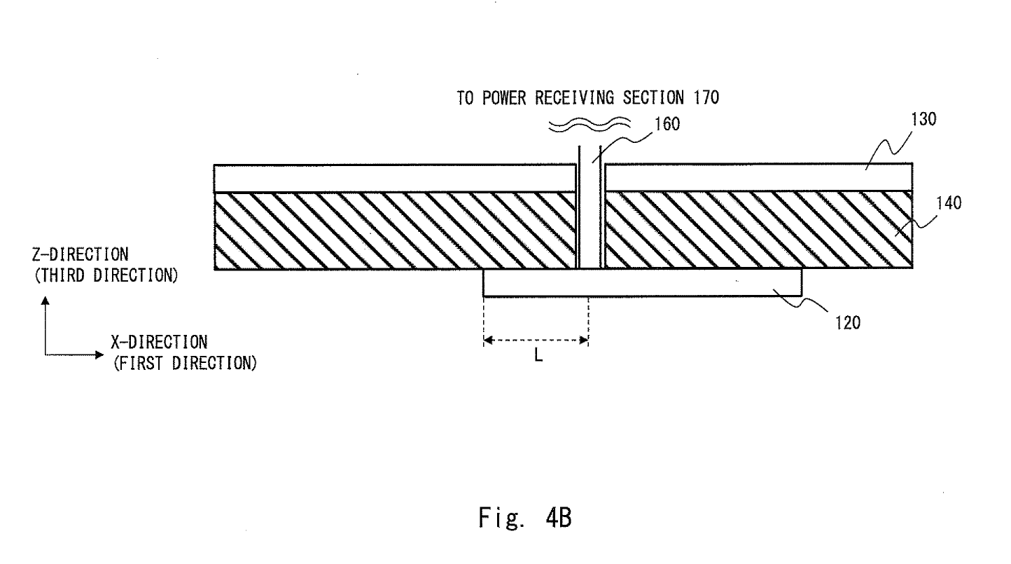

FIG. 3 is a bottom view of a power receiving apparatus 100 according to the first exemplary embodiment. FIG. 4A is a cross section of the power receiving apparatus 100 taken along the line IVA-IVA and FIG. 4B is a cross section of the power receiving apparatus 100 taken along the line IVB-IVB. In the following explanation, the crosswise direction and the lengthwise direction of the power receiving apparatus 100 are defined as “x-direction” and “y-direction”, respectively. Further, the vertical direction is defined as “z-direction”.

The x-direction, which is the crosswise direction of the power receiving apparatus 100, coincides with the traveling direction (propagation direction) of an electromagnetic wave propagating through the communication sheet 10 when the power receiving apparatus 100 is placed on the communication sheet 10 in a normal use state. Therefore, the X-direction is also referred to as a “traveling direction” of an electromagnetic wave in the following explanation.

The power receiving apparatus 100 according to the first exemplary embodiment includes a first conductor section 110, a second conductor section 120, a third conductor section 130, a substrate 140, a first path conductor section 150, a second path conductor section 160, and a power receiving section 170.

Each of the first and second conductor sections 110 and 120 is a conductor coupling element made of metal or the like that couples with an electromagnetic wave propagating through the communication sheet 10 and thereby receives electric power from the communication sheet 10. The first and second conductor sections 110 and 120 are arranged side by side on the bottom surface of the substrate 140.

Specifically, each of the first and second conductor sections 110 and 120 is a plate-like patch antenna having a roughly rectangular planar shape. Note that the term “patch” means a strip or a piece and is commonly used to express such objects in the field of electromagnetic-wave engineering. For example, a plate-like micro-strip antenna is called a “patch antenna” in the technical field. In this example, assume that the shapes of the first and second conductor sections 110 and 120 are roughly the same as each other.

Further, since each of the first and second conductor sections 110 and 120 has a function of taking out electric power by coupling with an electromagnetic wave, they are also called “couplers”.

The width of the first conductor section 110 in the x-direction, which is the electromagnetic-wave traveling direction, is roughly equal to the half-wavelength of the effective wavelength λ (λ/2) of the electromagnetic wave propagating through the communication sheet 10. Similarly, the width of the second conductor section 120 in the x-direction, which is the electromagnetic-wave traveling direction, is roughly equal to the half-wavelength of the effective wavelength λ (λ/2) of the electromagnetic wave propagating through the communication sheet 10. Note that both ends of each of the first and second conductor sections 110 and 120 in the x-direction are open ends.

By setting the width of each of the first and second conductor sections 110 and 120 in the electromagnetic-wave traveling direction to a value close to the half-wavelength of the effective wavelength λ, each of the first and second conductor sections 110 and 120 can efficiently couple with the electromagnetic wave, thus enabling electric power to be efficiently taken out.

Note that the first and second conductor sections 110 and 120 are attached in such a manner that they are shifted from each other by a predetermined distance in a direction (x-direction) perpendicular to the direction (y-direction) in which they are arranged side by side.

By arranging two conductor sections in this arrangement in which they are shifted from each other in the traveling direction of the electromagnetic wave propagating through the communication sheet 10, the electric-field distribution of the electromagnetic wave coupling with the power receiving apparatus 100 is different from that of the electromagnetic wave coupling with the second conductor section 120.

The electric power taken out from each of the respective conductor sections is fed to the power receiving section 170 through the first and second path conductor sections 150 and 160, respectively.

The substrate 140 is a sheet-like dielectric substrate. Further, the third conductor section 130 is disposed on the surface of the substrate 140 that is opposite to the surface in which the first and second conductor sections 110 and 120 are disposed. Further, through holes or notches through each of which a respective one of the first and second path conductor sections 150 and 160 passes are formed in the substrate 140.

The third conductor section 130 is electrically connected to a ground potential and thereby forms a ground layer. The third conductor section 130 is disposed so as to be opposed to at least both the first and second conductor sections 110 and 120. Further, in the third conductor section 130, two through holes or notches through which the first and second path conductor sections 150 and 160 pass in a noncontact state are formed.

As described above, each of the first and second conductor sections 110 and 120, which are patch antennas, is disposed between the third conductor section 130, which is the reference ground, and the communication sheet 10. Each of the first and second conductor sections 110 and 120 couples with an electromagnetic wave leaking from the communication sheet 10 and resonates at its specific frequency. As a result, electric power is taken out.

Since each of the first and second conductor sections 110 and 120 has a function of receiving electric power by coupling and resonating with an electromagnetic wave leaking from the communication sheet 10, they are also called a “first electromagnetic wave coupling unit” and a “second electromagnetic wave coupling unit”, respectively, or called a “first resonance unit” and a “second resonance unit”, respectively, in the following explanation. Further, the third conductor section 130, which is connected to the ground potential and thereby forms the reference ground, is also referred to as a “ground conductor section” in the following explanation.

The first path conductor section 150 is a conductor that electrically connects the first conductor section 110 with the power receiving section 170. One end of the first path conductor section 150 is connected to a power receiving point of the first conductor section 110 and the other end of the first path conductor section 150 is connected to the power receiving section 170 through the through holes or notched formed in the substrate 140 and the third conductor section 130, respectively.

Note that the connection point between the first path conductor section 150 and the first conductor section 110 is connected to a point where the impedances can be matched. FIG. 4A shows a case where the first path conductor section 150 is connected to the first conductor section 110 at a point a distance L away from one end of the first conductor section 110.

The second path conductor section 160 is a conductor that electrically connects the second conductor section 120 with the power receiving section 170. One end of the second path conductor section 160 is connected to a power receiving point of the second conductor section 110 and the other end of the second path conductor section 160 is connected to the power receiving section 170 through the through holes or notched formed in the substrate 140 and the third conductor section 130, respectively.

Note that the connection point between the second path conductor section 160 and the second conductor section 120 is connected to a point where their impedances can be matched. Similarly to the first path conductor section 150, FIG. 4B shows a case where the second path conductor section 160 is connected to the second conductor section 120 at a point a distance L away from one end of the second conductor section 120.

As a specific example, each of the first and second path conductor sections 150 and 160 can be a conductor via (short-circuit via) disposed in an upright position in a respective one of the first and second conductor sections 110 and 120. Further, the core wire of a coaxial cable that passes through the through holes formed in the third conductor section 130 and the substrate 140, respectively, and is soldered to the first conductor section 110, for example, may be used as the first path conductor section 150. Similarly, the second path conductor section 160 can also be formed by using the core wire of a coaxial cable. The outer conductors of the coaxial cables are soldered to the third conductor section 130.

As described above, a first resonator is formed by the first conductor section 110 and the third conductor section 130, which are opposed to each other with the substrate 140 interposed therebetween. Further, a second resonator is formed by the second conductor section 120 and the third conductor section 130, which are opposed to each other with the substrate 140 interposed therebetween. Electric power obtained in each resonator is sent to the power receiving section 170 through a respective one of the first and second path conductor sections 150 and 160.

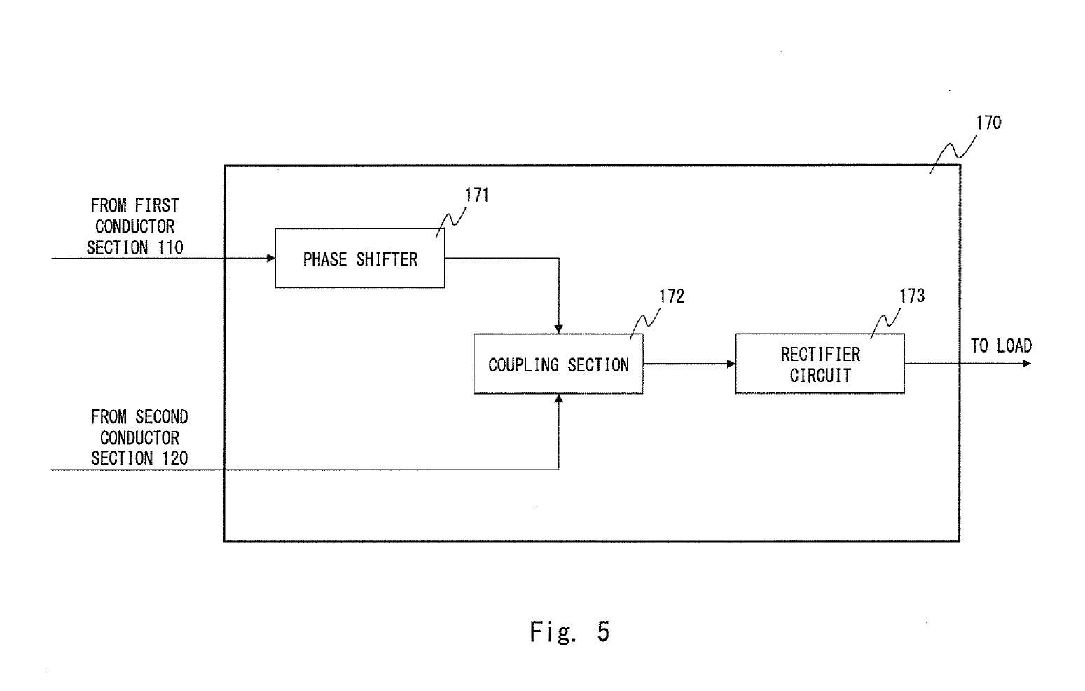

The power receiving section 170 combines the electric power sent from the first and second path conductor sections 150 and 160 and thereby obtains combined electric power. FIG. 5 shows an example of a specific configuration of the power receiving section 170.

In FIG. 5, the power receiving section 170 includes a phase shifter 171, a coupling section 172, and a rectifier circuit 173.

The phase shifter 171 is electrically connected to the first conductor section 110 through the first path conductor section 150. The phase shifter 171 has a function of shifting the phase of electric power sent through the first path conductor section 150 by a predetermined amount. Note that when the electrical length of the path from the first conductor section 110 to the coupling section 172 is equal to that from the second conductor section 120 to the coupling section 172, the phase delay amount, which indicates the amount of the phase shift of the electric power set in the phase shifter 171, corresponds to the shift amount X between the positions of the first and second conductor sections 110 and 120. Since the phase shifter 171 makes an adjustment so that the outputs from the first and second conductor sections 110 and 120 are temporally in coordinated phase with each other, the electric power are mutually strengthened.

The coupling section 172 electrically connects the connection point of the second path conductor section 160 with the connection point of the phase shifter 171. A Wilkinson Power Combiner, for example, can be used for the coupling section 172. The coupling section 172 combines the alternating-current (hereinafter referred to as “AC”) power sent from the second path conductor section 160 with the AC power, whose phase has been adjusted by the phase shifter 171, and sends the combined AC power to the rectifier circuit 173.

A double voltage rectifier circuit, for example, can be used for the rectifier circuit 173. The rectifier circuit 173 converts the combined AC power sent from the coupling section 172 into a combined direct-current (hereinafter referred to as “DC”) power.

As described above, the power receiving section 170 obtains combined electric power by combining the electric power received in the first conductor section 110 with the electric power received in the second conductor section 120. With this configuration, even when one of the conductor sections is positioned in a place corresponding to a node of the standing wave and hence sufficient electric power cannot be taken out by that conductor section, sufficient electric power can be taken out by the other conductor section. By combining these two electric power outputs, it is possible to receive electric power while minimizing the influence by the standing wave.

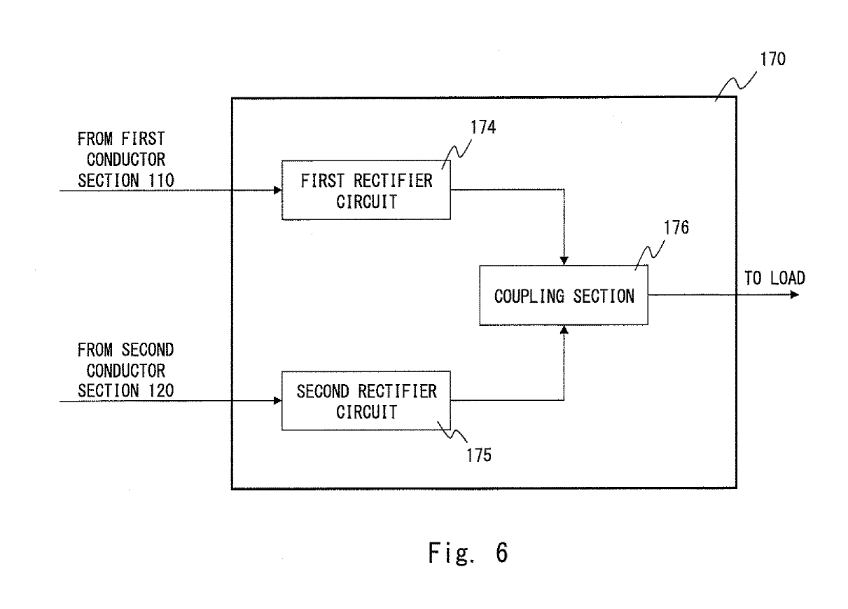

Note that the configuration of the power receiving section 170 is not limited to the above-described configuration shown in FIG. 5. FIG. 6 is a block diagram showing a configuration of the power receiving section 170 in another form.

In FIG. 6, the power receiving section 170 includes a first rectifier circuit 174, a second rectifier circuit 175, and a coupling section 176.

The first rectifier circuit 174 is electrically connected to the first conductor section 110 through the first path conductor section 150 and converts the AC power sent through the first path conductor section 150 into DC power.

The second rectifier circuit 175 is electrically connected to the second conductor section 120 through the second path conductor section 160 and converts the AC power sent through the second path conductor section 160 into DC power.

The coupling section 176 combines the DC power output from the first rectifier circuit 174 with that from the second rectifier circuit 175 and thereby obtains combined electric power.

In the configuration shown in FIG. 6, the electric power received in the first conductor section 110 can also be combined with that received in the second conductor section 120 in the power receiving section 170, thus making it possible to receive electric power while minimizing the influence by the standing wave.

The power receiving section shown in FIG. 5 includes a smaller number of rectifier circuits than that in the power receiving section shown in FIG. 6, thus providing an advantage that the cost for the components can be reduced. On the other hand, it is necessary to align, by using a phase shifter(s), the phases of the voltages, each of which is obtained by coupling with an electromagnetic wave in a respective one of the first and second conductor sections 110 and 120 and sent from that conductor section, so that these voltages are not cancelled out by each other. Depending on the frequency of an electromagnetic wave propagating through the communication sheet 10 and/or its propagation state, it could be very difficult to align the phases of the two voltages that are generated by coupling with the electromagnetic wave in the respective conductor sections. In such cases, by adopting a configuration in which the two AC power outputs sent from the respective conductor sections are first rectified by respective rectifier circuits and then the rectified power outputs are combined as in the case of the power receiving section shown in FIG. 6, it is possible to obtain stable combined electric power.

Next, an arrangement relation between the first and second conductor sections 110 and 120 is explained. As described above, the first and second conductor sections 110 and 120 are arranged side by side in a direction perpendicular to the traveling direction of the electromagnetic wave propagating through the communication sheet 10 in a state where they are shifted from each other by a predetermined shift amount X in the electromagnetic-wave traveling direction.

By arranging the first and second conductor sections 110 and 120 in this manner in which they are shifted from each other by the predetermined shift amount X in the electromagnetic-wave traveling direction, the electric-field distribution of the electromagnetic wave coupling with the first conductor section 110 is made different from that of the electromagnetic wave coupling with the second conductor section 120.

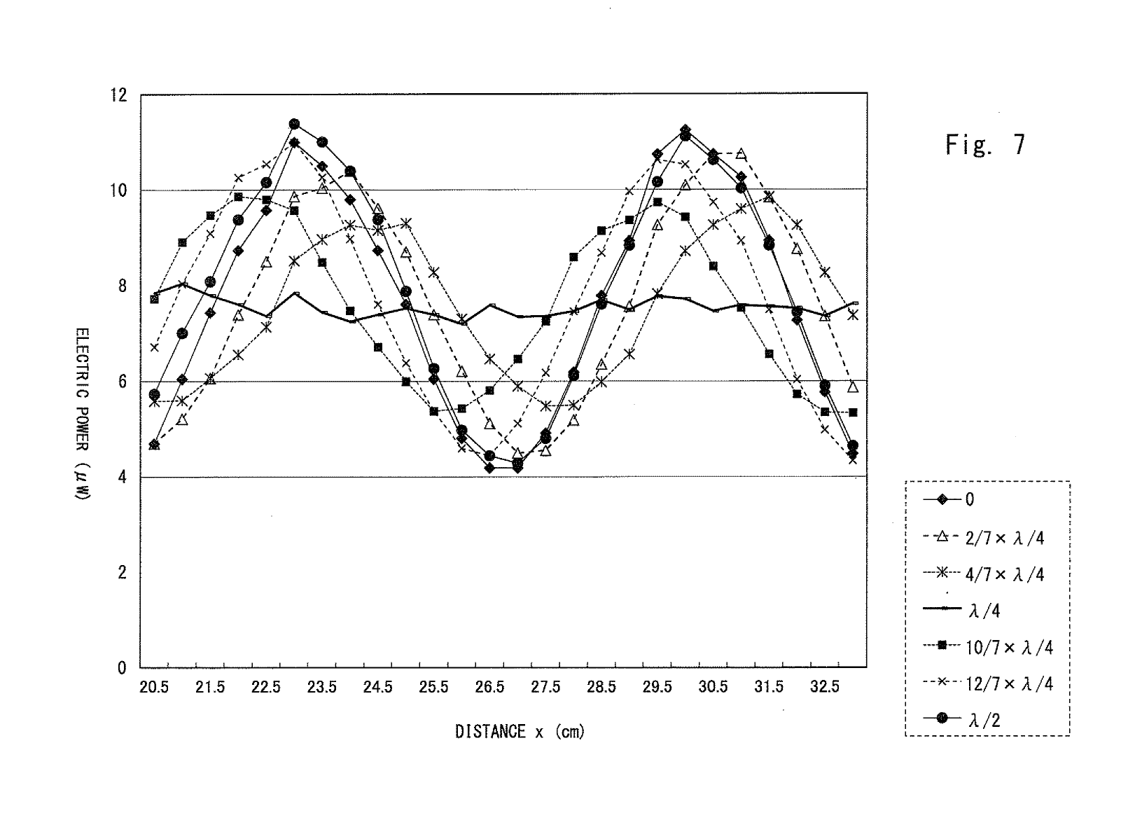

FIG. 7 is a graph showing values of the combined electric power obtained in the power receiving section 170 when the shift amount X between the first and second conductor sections 110 and 120 in the electromagnetic-wave traveling direction is changed. In this example, values of the combined electric power in a case where an input of 1 mW is supplied to the communication sheet are shown. It should be noted that the combined electric power increases as the input power increases.

As can be seen from FIG. 7, when the first and second conductor sections 110 and 120 are arranged side by side in the y-direction without shifting them from each other at all, the combined electric power is affected by the standing wave and minimum values of the combined electric power appear at a cycle of about 7 cm, which corresponds to the half-wavelength of the effective wavelength λ.

When the first and second conductor sections 110 and 120 are arranged side by side without shifting them from each other at all, the maximum value of the combined electric power, which is about 11 μW, is about three times higher than the minimum value, which is about 4 μW. When there is such large positional selectivity on a communication sheet, a user needs to select a place having excellent power receiving sensitivity when the user actually uses the communication sheet, thus preventing the user from taking the advantage of the communication sheet. To exploit the advantage of the communication sheet, the received power in a place where the received power is weak on the communication sheet 10 is preferably no less than ½ of the received power in a place where the received power is strong.

As can be seen from FIG. 7, when the distance (shift amount) X between one end of the first conductor section 110 and that of the second conductor section 120 satisfies a relation “(4/7)×(λ/4)≦X≦(10/7)×(λ/4)”, the minimum value of the combined electric power is 5.34 μW and the maximum value of the combined electric power is 9.86 μW. Therefore, the maximum value is not greater than twice the minimum value. Therefore, the positional selectivity can be reduced by adjusting the distance X between the open end of the first conductor section 110 and that of the second conductor section 120 in the electromagnetic-wave traveling direction to a value satisfying the relation (4/7)×(λ/4)≦X≦(10/7)×(λ/4).

In particular, when the distance X between between one end of the first conductor section 110 and that of the second conductor section 120 is λ/4, it is possible to take out stable combined electric power in a range from 7.2 μW to 8.0 μW from the two conductor sections irrespective of the place of the conductor sections. Therefore, a user can place the power receiving apparatus 100 without giving any consideration to the positional selectivity on the communication sheet to receive electric power.

As explained above, the power receiving apparatus according to the first exemplary embodiment includes two conductor coupling elements, i.e., the first conductor section 110 that couples with an electromagnetic wave propagating through the communication sheet 10 and thereby receives electric power, and the second conductor section 120 that couples with an electromagnetic wave propagating through the communication sheet 10 and thereby receives electric power. Further, first and second resonators are formed by disposing the third conductor section 130 connected to a ground potential in a position a predetermined distance away from the first and second conductor sections 110 and 120 in an opposed state.

It should be noted that the first and second conductor sections 110 and 120 are arranged so as to satisfy such a relation that the electric field of the electromagnetic wave, which couples with the first conductor section 110, for the first conductor section 110 has a roughly opposite phase to the phase of the electric field of the electromagnetic wave, which couples with the second conductor section 120, for the second conductor section 120 in a state where the power receiving apparatus is placed on the communication sheet 10.

Specifically, this condition can be achieved by adjusting the distance in a first direction between one end of the first conductor section 110 in the first direction and that of the second conductor section 120 in the first direction to a value from 2λ/14 to 5λ/14, where λ is the effective wavelength of the electromagnetic wave propagating through the communication sheet 10.

In particular, an excellent result can be obtained by adjusting the distance in the x-direction between one end of the first conductor section 110 in the first direction and that of the second conductor section 120 in the first direction to a value roughly equal to a quarter of the effective wavelength λ of the electromagnetic wave propagating through the communication sheet 10.

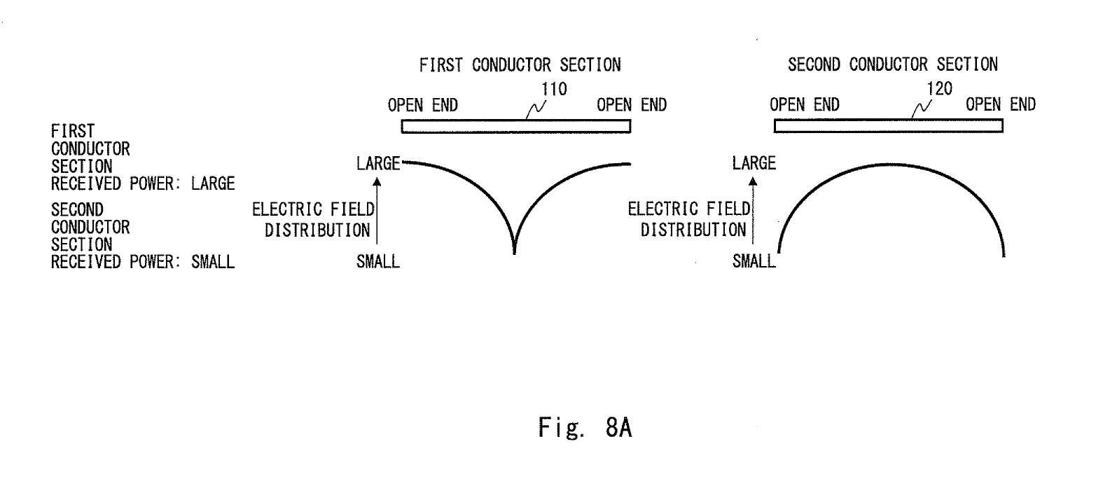

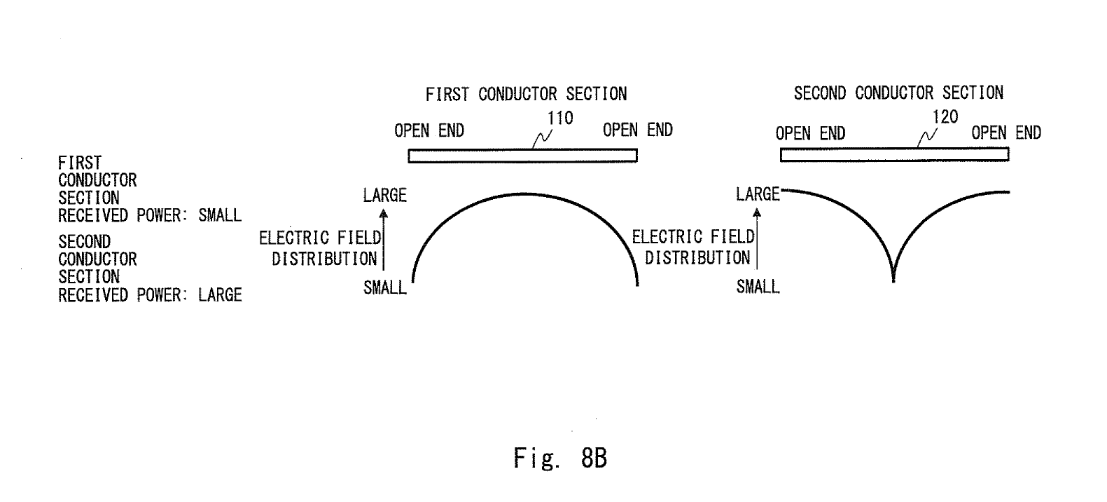

FIGS. 8A and 8B show electric field distributions for the first and second conductor sections 110 and 120, respectively, when the power receiving apparatus 100 in which the distance in the x-direction between the first and second conductor sections 110 and 120 is adjusted to λ/4 is placed on the communication sheet 10. In FIG. 8A, since the open ends of the first conductor section 110 coincide with the positions of antinodes of the standing wave, the received power from the first conductor section 110 is maximized. On the other hand, since the open ends of the second conductor section 120, which is shifted in the x-direction by a distance λ/4, coincide with the positions of nodes of the standing wave, the received power from the second conductor section 120 is minimized.

FIG. 8B shows the electric field distributions for the first and second conductor sections 110 and 120 in a case where the power receiving apparatus 100 is shifted in the x-direction by λ/4. In this case, since the open ends of the first conductor section 110 coincide with the positions of nodes of the standing wave, the received power from the first conductor section 110 is minimized. On the other hand, since the open ends of the second conductor section 120, which is shifted in the x-direction by a distance λ/4, coincide with the positions of antinodes of the standing wave, the received power from the second conductor section 120 is maximized.

Since the first and second conductor sections 110 and 120 have such a relation that their received power outputs complement each other, the positional selectivity of the combined electric power can be reduced.

Note that although examples in which the interface apparatus is a power receiving apparatus are explained in the above explanation, similar configurations can also be used for cases where the interface apparatus is a communication apparatus or/and a power supply apparatus. That is, it is possible to use a configuration in which two conductor sections, i.e., first and second conductor sections are provided as antenna elements and they are arranged so that the distance X between one end of the first conductor section and that of the second conductor section satisfies a relation “2λ/14≦X≦5λ/14”.

### Second Exemplary Embodiment

In the power receiving apparatus according to the first exemplary embodiment, the first and second conductor sections, which are conductor coupling elements having roughly similar shapes, are arranged in a state where they are shifted from each other in the electromagnetic-wave traveling direction, so that they have such a relation that the relative phases of the electromagnetic waves coupling with the respective conductor sections are opposite to each other.

It should be noted that since the two conductor coupling elements having similar shapes are arranged while they are shifted from each other in the power receiving apparatus according to the first exemplary embodiment, there is a problem that the width of the power receiving apparatus increases in the electromagnetic-wave traveling direction. This power receiving apparatus can be incorporated into a device disposed in a relatively large laptop computer. However, for smaller mobile devices, it is desirable to reduce the power receiving apparatus in size because the device size of such mobile devices is restricted.

A power receiving apparatus according to a second exemplary embodiment deals with the above-described another problem while enabling a stable power receiving operation. The following explanation is given with reference to the drawings. Note that the explanations of components/structures that have already been explained in the first exemplary embodiment are partially omitted for clarifying the invention.

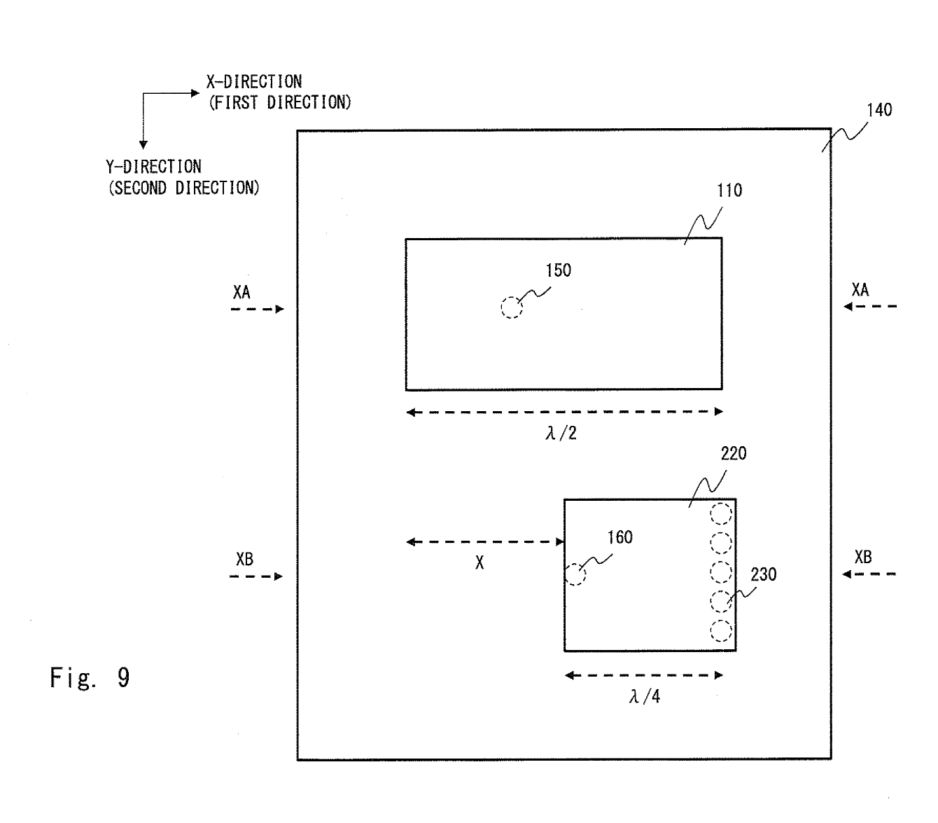

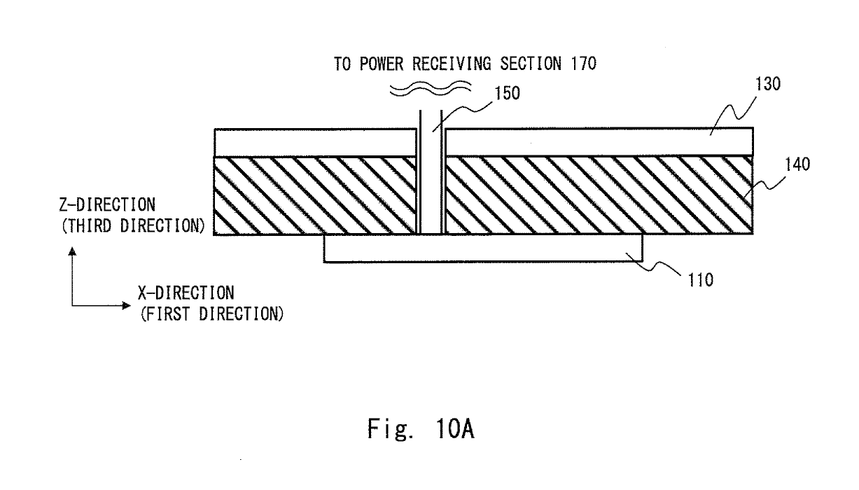

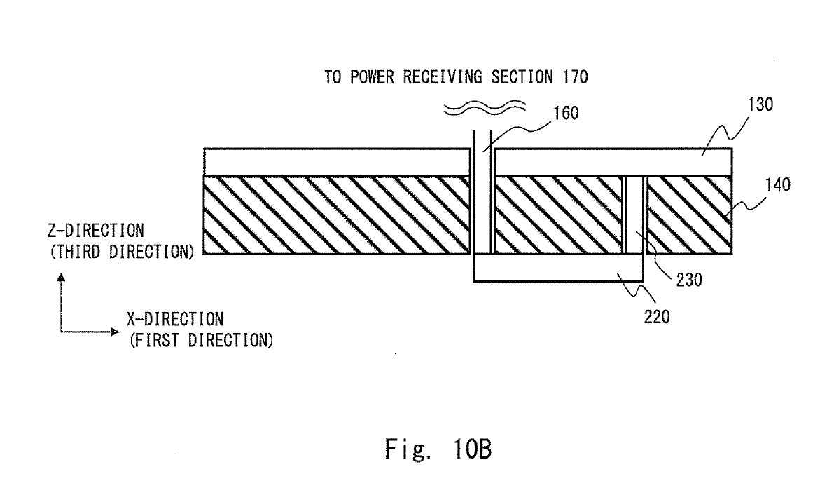

FIG. 9 is a bottom view of a power receiving apparatus 200 according to the second exemplary embodiment. FIG. 10A is a cross section of the power receiving apparatus 200 taken along the line XA-XA and FIG. 10B is a cross section taken along the line XB-XB.

The power receiving apparatus according to the second exemplary embodiment includes a first conductor section 110, a second conductor section 220, a third conductor section 130, a substrate 140, a first path conductor section 150, a second path conductor section 160, a power receiving section 170, and conductor vias 230.

The first conductor section 110, the third conductor section 130, the substrate 140, the first and second path conductor sections 150 and 160, and the power receiving section 170 have already been explained in the first exemplary embodiment, and therefore their explanations are omitted.

The second conductor section 220 in the second exemplary embodiment is characterized in that its width in the electromagnetic-wave traveling direction is about half of that of the second conductor section 120 in the first exemplary embodiment. That is, the width of the second conductor section 220 in the electromagnetic-wave traveling direction is adjusted to a value roughly equal to a quarter of the effective wavelength λ (λ/4) of the electromagnetic wave.

The first and second conductor sections 110 and 220 are arranged side by side in a state where they are a predetermined distance away from each other in the y-direction. It should be noted that the first and second conductor sections 110 and 220 are arranged side by side in a state where one end of the first conductor section 110 in the electromagnetic-wave traveling direction is aligned with that of the second conductor section 220 in the x-direction.

The one end of the second conductor section 220, which is aligned with that of the first conductor section 110, is electrically connected and thus short-circuited to the third conductor section 130 through the conductor vias 230. Each of the conductor vias 230 is a conductor that connects and thus short-circuits the second conductor section 220 to the third conductor section 130. In the power receiving apparatus 200 shown in FIG. 9, five conductor Vias 230 are disposed in an upright position at the end of the second conductor section 220 at intervals that are sufficiently narrower than the effective wavelength of the electromagnetic wave.

The end of the second conductor section 220 opposite to the end, where the conductor vias 230 are disposed, is not short-circuited and hence is an open end. The second path conductor section 160 is disposed on this open end side.

As described above, the second exemplary embodiment is characterized in that electric power is taken out by using the two conductors, i.e., the first conductor section 110 whose ends are both open ends and the second conductor section 220 which has a width in the electromagnetic-wave traveling direction roughly equal to half of that of the first conductor section 110 and whose one end is a short-circuited end and other end is an open end.

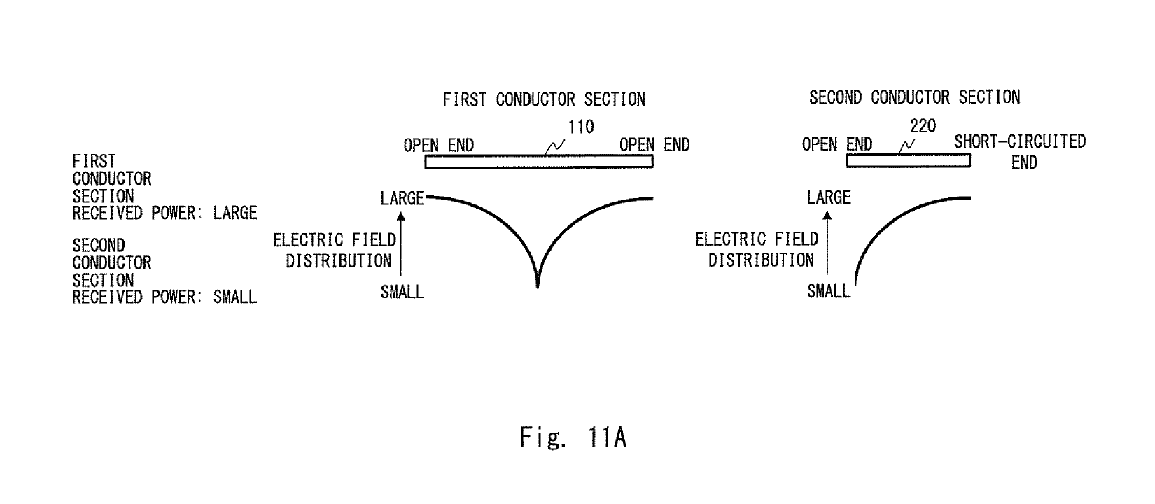

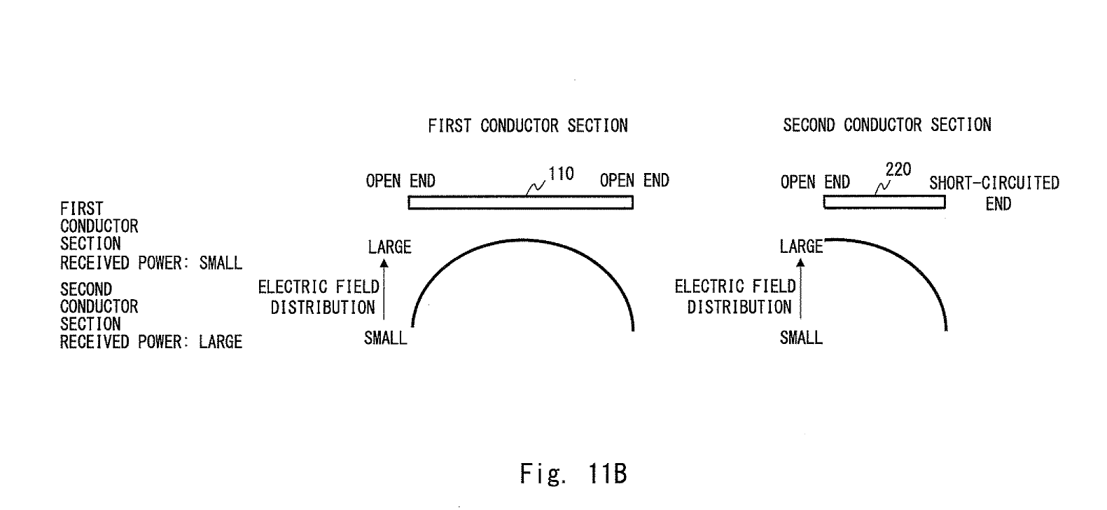

FIGS. 11A and 11B show electric field distributions for the first and second conductor sections 110 and 220, respectively, when the power receiving apparatus 200 is placed on the communication sheet 10. In FIG. 11A, since the open ends of the first conductor section 110 coincide with the positions of antinodes of the standing wave, the received power from the first conductor section 110 is maximized. Meanwhile, the second conductor section 220 is disposed so that its open end is positioned in a place a distance λ/4 away from one of the open ends of the first conductor section 110 in the x-direction. Therefore, since the open end of the second conductor section 220 coincides with the position of a node of the standing wave, the received power from the second conductor section 220 is minimized.

FIG. 11B shows the electric field distributions for the first and second conductor sections 110 and 220 in a case where the power receiving apparatus 200 is shifted in the x-direction by a distance λ/4. In this case, since the open ends of the first conductor section 110 coincide with the positions of nodes of the standing wave, the received power from the first conductor section 110 is minimized. On the other hand, since the open end of the second conductor section 220 coincides with the position of an antinode of the standing wave, the received power from the second conductor section 220 is maximized. The electric field at the short-circuited end of the second conductor section 220 decreases, while the electric field at and near the open end, where the second path conductor section 160 is disposed, increases, thus enabling electric power to be taken out.

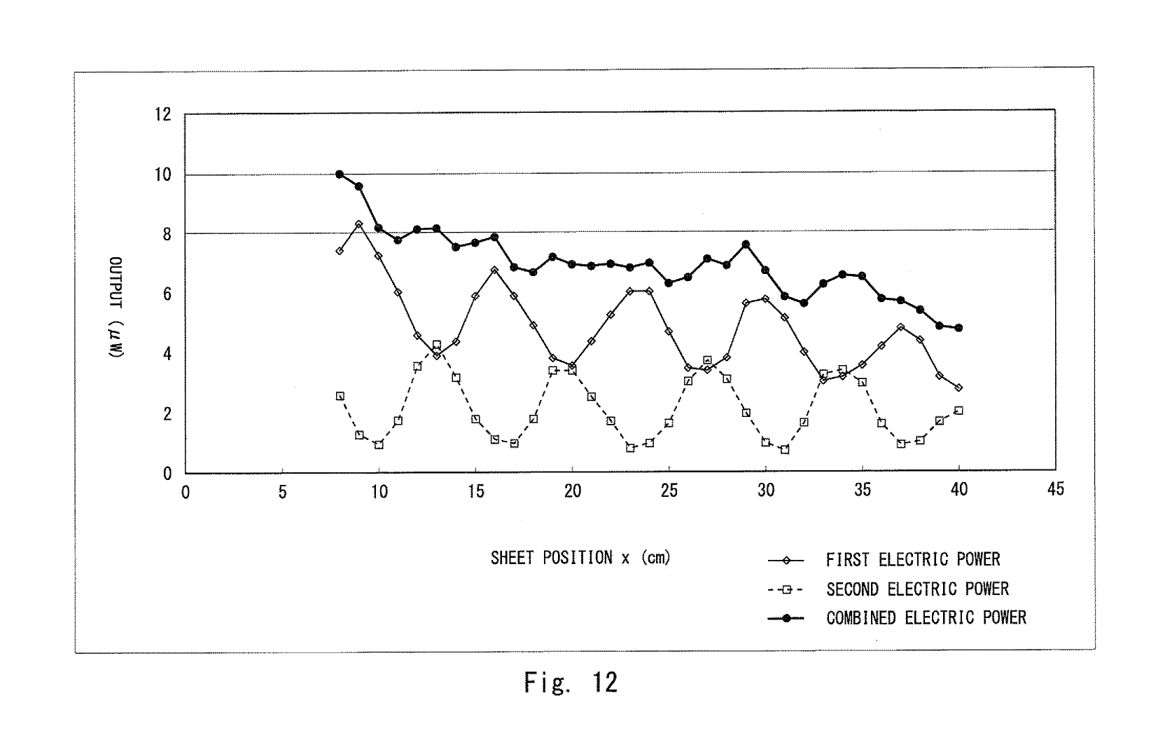

FIG. 12 shows electric power outputs each obtained in a respective one of the first and second conductor sections 110 and 220 and combined electric power obtained by combining them in the power receiving section 170 when the position of the power receiving apparatus 200 on the communication sheet 10 is changed in the electromagnetic-wave traveling direction (x-direction).

As shown in FIG. 12, since the electromagnetic wave is fed from the end of the communication sheet 10, the obtained overall electric power decreases as the distance from the feeding point increases.

Further, the electric power obtained in each conductor section is affected by the standing wave and thus pulsates as the position of the power receiving apparatus 200 on the communication sheet 10 changes. That is, as shown in FIG. 12, for the electric power obtained in each conductor section, minimum values appear at a cycle of about 7 cm, which corresponds to the half-wavelength of the effective wavelength. It should be noted that since the electric power outputs obtained in the first and second conductor sections 110 and 220 have such a relation that the magnitudes of the obtained electric power outputs are reversed with respect to each other, they are cancelled out in magnitude by each other. As a result, the positional selectivity is reduced. As can be seen from FIG. 12, the values of the combined electric power are hardly affected by the standing wave.

As described above, the power receiving apparatus according to the second exemplary embodiment includes a first conductor section that is a patch electrode having a width in the electromagnetic-wave traveling direction roughly equal to the half-wavelength of the effective wavelength λ of an electromagnetic wave propagating through an electromagnetic-wave propagation sheet, and a second conductor section that is a patch electrode having a width in the electromagnetic-wave traveling direction roughly equal to a quarter of the effective wavelength λ of the electromagnetic wave propagating through the electromagnetic-wave propagation sheet. The first and second conductor sections are arranged in such a positional relation that they are a predetermined distance away from each other in a direction perpendicular to the electromagnetic-wave traveling direction.

Further, the power receiving apparatus is characterized in that one end of the second conductor section 220 in the electromagnetic-wave traveling direction is short-circuited to the third conductor section 130. The second path conductor section 160 is disposed at the end opposite to the short-circuited end of the second conductor section 220, and electric power received by the second conductor section 220 is sent to the power receiving section 170 through the second path conductor section 160.

According to this configuration, electric power outputs obtained in the two conductor sections have such a relation that the magnitudes of these outputs, which change according to their positions, are reversed with respect to each other. As a result, the positional selectivity for the combined electric power obtained by combining these electric power outputs obtained in these two conductor sections is reduced. Therefore, electric power can be received in any place on the electromagnetic-wave propagation sheet.

Note that although examples in which the second conductor section 220 is a patch electrode having a width roughly equal to half of that of the first conductor section 110 are explained in the above explanation, the present invention is not limited to these examples. The power receiving apparatus may be designed so that the second conductor section 220 becomes a 50Ω path by adjusting the width in the direction appendicular to the electromagnetic-wave traveling direction.

Further, although examples in which the first and second conductor sections 110 and 220 are arranged so that the position of the open end of the first conductor section 110 is about λ/4 away from that of the second conductor section 220 are explained in the above explanation, the present invention is not limited to these examples. Similarly to the first exemplary embodiment, the positional selectivity can be reduced by adjusting the distance in the first direction between the open end of the first conductor section 110 in the first direction and that of the second conductor section 220 in the first direction to a value from 2λ/14 to 5λ/14, where λ is the effective wavelength of the electromagnetic wave propagating through the communication sheet 10.

Further, although examples in which the second path conductor section 160 is disposed near the open end of the second conductor section 220 are explained in the above explanation, the present invention is not limited to these examples. Similarly to the first path conductor section 150 connected to the first conductor section 110, the second path conductor section 160 may be disposed in a place a distance L away from the open end of the second conductor section 220.

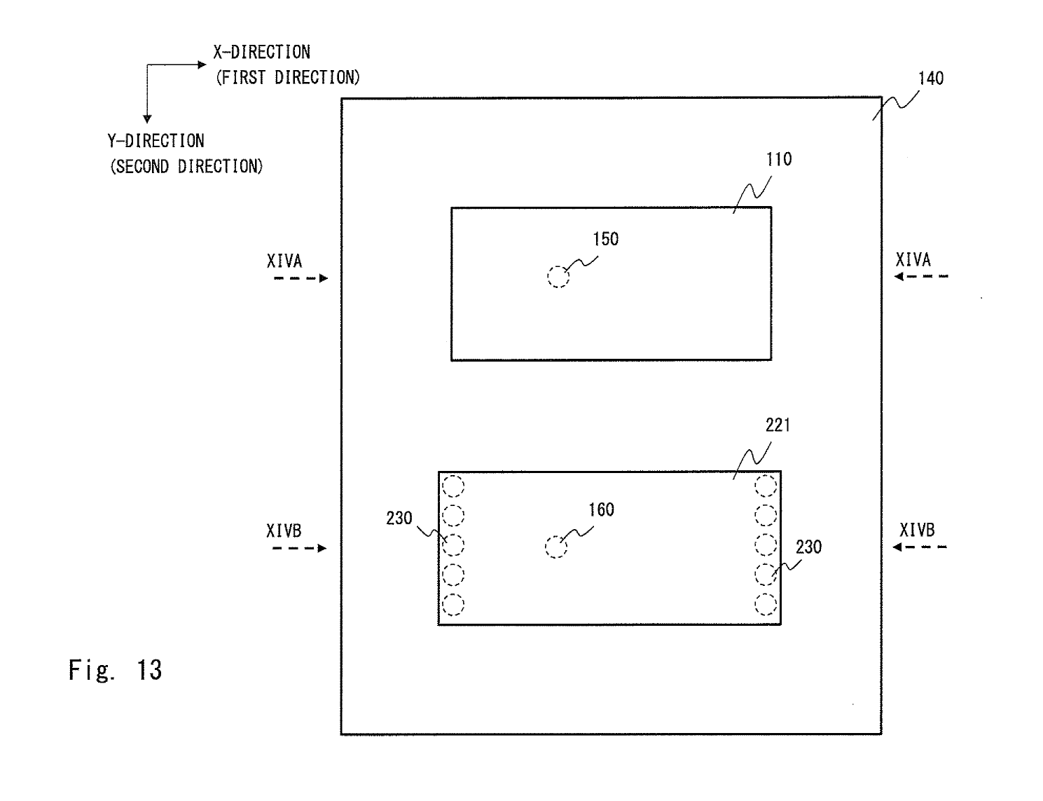

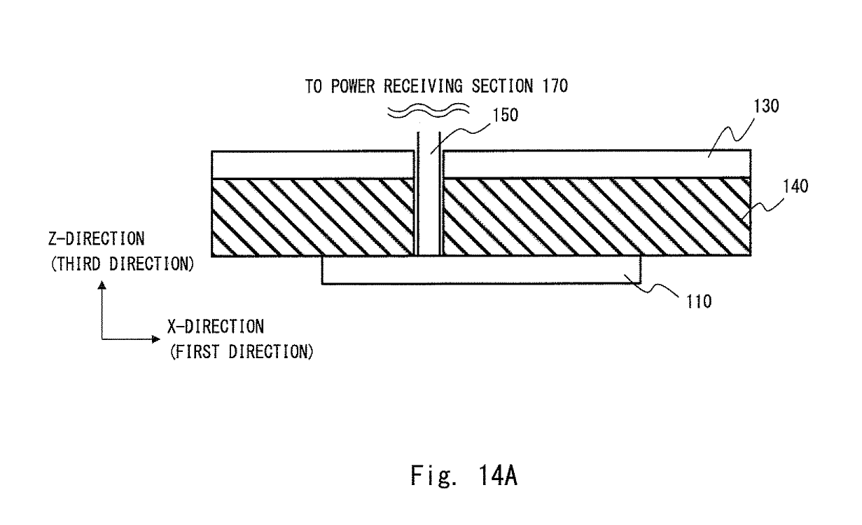

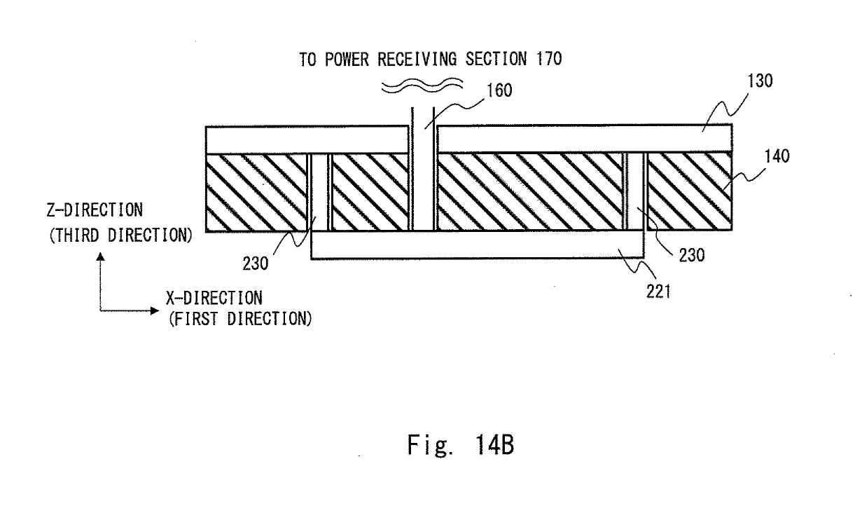

Further, as shown in FIGS. 13, 14A and 14B, a conductor section that has a width twice as long as that of the second conductor section 220 and is folded back may be used as a second conductor section 221. In this case, conductor vias 230 are disposed on both ends of the second conductor section 221 and both ends are thereby short-circuited.

That is, the power receiving apparatus shown in FIGS. 13, 14A and 14B includes two conductor sections, i.e., a first conductor section 110 having a width in a first direction roughly equal to the half-wavelength of the effective wavelength λ of an electromagnetic wave propagating through an electromagnetic-wave propagation sheet, and a second conductor section 221 having a width in the first direction roughly equal to the half-wavelength of the effective wavelength λ of an electromagnetic wave propagating through the electromagnetic-wave propagation sheet. The first and second conductor sections 110 and 221 are arranged side by side with each other in a second direction (y-direction) perpendicular to the first direction (x-direction). The third conductor section 130 connected to the ground potential is disposed in an opposed state to the first and second conductor sections 110 and 221. The first and second conductor sections 110 and 221 are electrically connected to the power receiving section 170 through the first and second path conductor sections 150 and 160, respectively. The power receiving section 170 combines electric power received by the first conductor section 110 with that received by the second conductor section 221. Note that both ends in the first direction of the first conductor section 110 are open ends, and both ends in the first direction of the second conductor section 221 are short-circuited ends. Conductor vias 230 that connect the second conductor section 221 with the third conductor section 130 are disposed at both ends of the second conductor section 221, so that both ends of the second conductor section 221 are short-circuited ends.

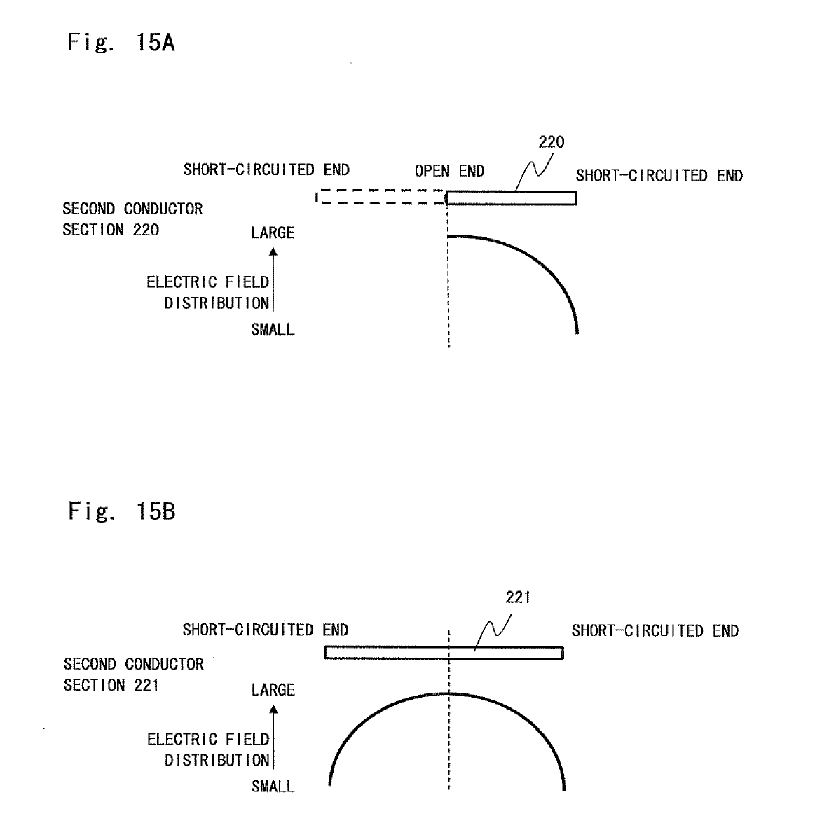

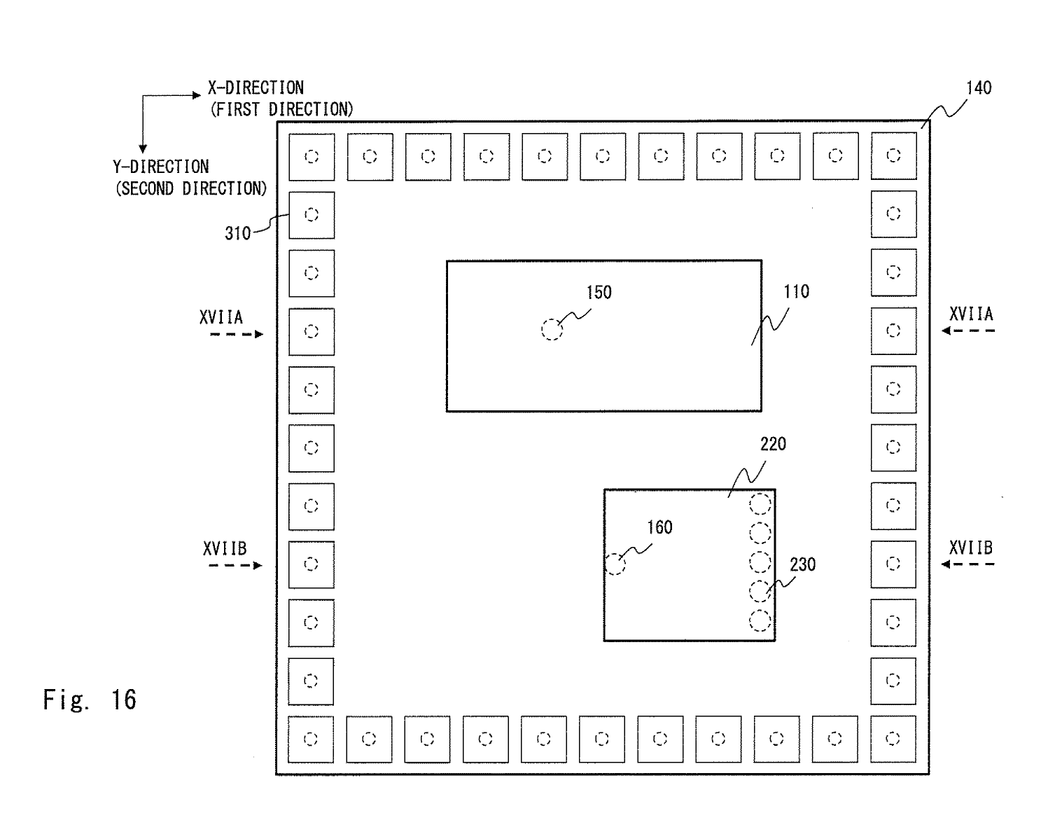

As shown in FIGS. 15A and 15B, the second conductor section 221 shown in FIGS. 13, 14A and 14B has such a configuration that another second conductor section 220 is disposed in a place that is axisymmetric to the second conductor section 220 shown in FIGS. 9, 10A and 10B, with the position of the open end of that second conductor section 220 being the symmetry axis. Therefore, the received power in the second conductor section 221 is larger than that in the second conductor section 220. This configuration can also be used for the second conductor section.

As described above, in the power receiving apparatus according to the second exemplary embodiment, the received power received in the first conductor section also has a complementary relation with that received in the second conductor section. That is, as observed in the electromagnetic-wave traveling direction of the communication sheet, the first and second conductor sections are disposed so that the position where the received power received in the first conductor section is maximized roughly coincides with the position where the received power received in the second conductor section is minimized. Further, the first and second conductor sections are disposed so that the position where the received power received in the first conductor section is minimized roughly coincides with the position where the received power received in the second conductor section is maximized. Therefore, for the combined electric power obtained by combining the received power received in the first conductor section with that received in the second conductor section, the influences by the standing wave are cancelled out, thus enabling a stable power receiving operation.

### Third Exemplary Embodiment

When electric power is received in a power receiving apparatus placed on a communication sheet, a part of the electromagnetic wave could leak through an insulator section located between the meshed conductor section of the communication sheet and the conductor section on the power receiving apparatus side.

The occurrence of an electromagnetic wave leak like this not only gives an adverse effect to the outside but also deteriorates the power receiving efficiency. Therefore, the object of the third exemplary embodiment is to provide a power receiving apparatus capable of reducing the leaked electromagnetic wave and thereby improving the power receiving efficiency. The following explanation is given with reference to the drawings.

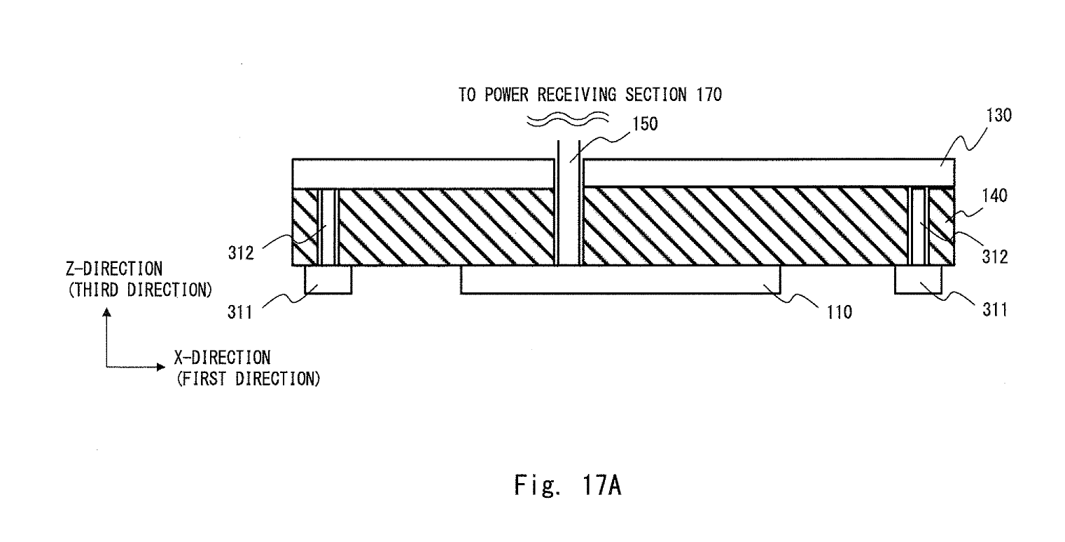

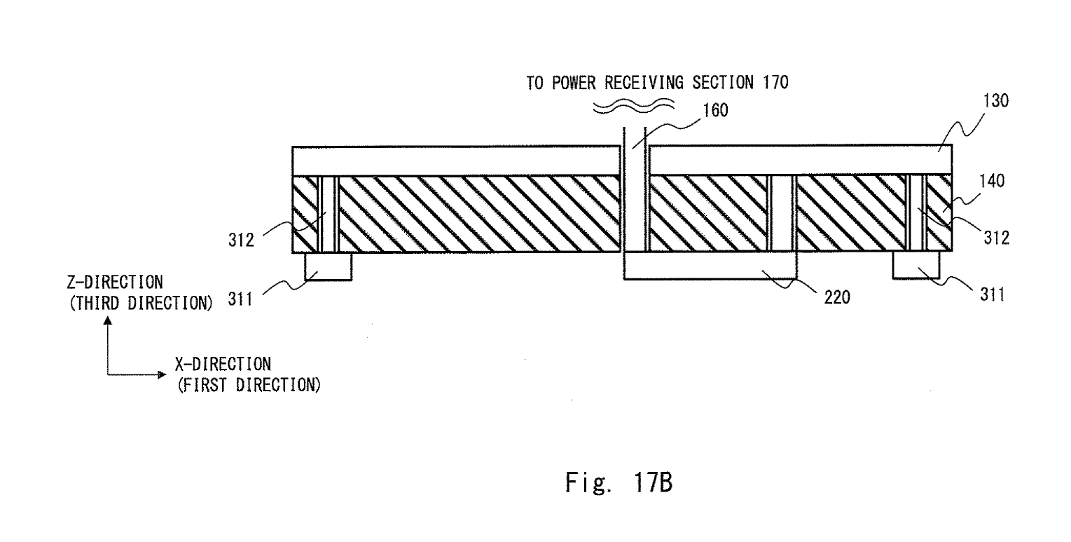

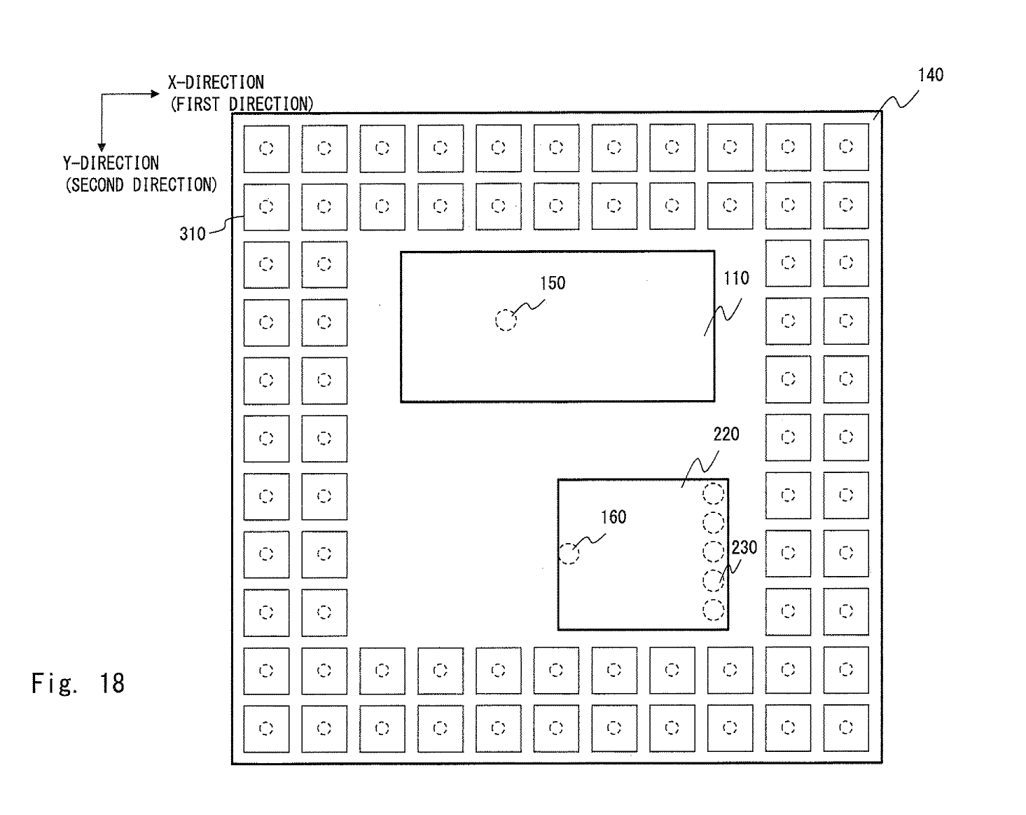

FIG. 16 is a bottom view of a power receiving apparatus 300 according to the third exemplary embodiment. FIG. 17A is a cross section of the power receiving apparatus 300 taken along the line XVIIA-XVIIA and FIG. 17B is a cross section of the power receiving apparatus 300 taken along the line XVIIB-XVIIB.

In the power receiving apparatus 300, a plurality of electromagnetic wave restraint structures 310 are arranged so as to surround a first conductor section 110 and a second conductor section 220.

The electromagnetic wave restraint structures 310 have a function of preventing an electromagnetic wave(s) sucked from the communication sheet 10 by the power receiving apparatus 300 from leaking to the outside. Specifically, each of the electromagnetic wave restraint structures 310 is an EBG (Electromagnetic Band-Gap) structure including a patch electrode 311 and a conductor via 312.

The patch electrode 311 is a plate-like conductor in contact with the communication sheet 10. Further, the patch electrode 311 is disposed on the same plane as the first and second conductor sections 110 and 220 and in contact with the communication sheet 10. Since the patch electrode 311 is a conductor for restraining an electromagnetic wave, it is also referred to as an “electromagnetic wave restraint conductor section” in the following explanation. The conductor Via 312 is a connection conductor section that electrically connects the patch electrode 311 with the third conductor section (ground conductor section) 130.

The patch electrodes 311 and the conductor vias 312 are designed so that the area between the patch electrodes 311 and the meshed conductor section 13 of the communication sheet 10 becomes a transmission path(s) having an extremely low or extremely high characteristic impedance. By doing so, an electromagnetic wave(s) which would otherwise leak is reflected and thereby confined within the power receiving apparatus.

As described above, the plurality of electromagnetic wave restraint structures 310 are arranged on the periphery of the substrate 140 so as to surround the first and second conductor sections 110 and 220. By adopting this configuration, an electromagnetic wave(s) taken out from the communication sheet 10 to the power receiving apparatus 300 can be prevented from leaking to the outside by reflecting the electromagnetic wave, which would otherwise leak to the outside through the area of the insulating section 14, i.e., the area between the power receiving apparatus 300 and the meshed conductor section 13 of the communication sheet 10.

Note that multiple tiers of electromagnetic wave restraint structures 310 may be arranged on the periphery of the substrate 140. The leaking electromagnetic wave can be reduced even further than the reduction by the single configuration shown in FIG. 16 by arranging two rows of electromagnetic wave restraint structures 310 as shown in FIG. 18. However, since a plurality of rows of electromagnetic wave restraint structures are arranged, the planar size of the power supplying apparatus increases. Therefore, the necessary number and the configuration of electromagnetic wave restraint structures 310 are preferably determined in view of the desired electromagnetic wave reduction level.

Further, the configuration of the electromagnetic wave restraint structures 310 may be designed so that the number of rows in the lengthwise direction (y-direction) of the electromagnetic wave restraint structures 310 is different from that in the crosswise direction (x-direction) of the electromagnetic wave restraint structures 310. When the length in the crosswise direction cannot be increased because the power receiving apparatus is incorporated into a laptop computer or the like, the number of rows in the crosswise direction of the electromagnetic wave restraint structures 310 may be smaller than that in the lengthwise direction.

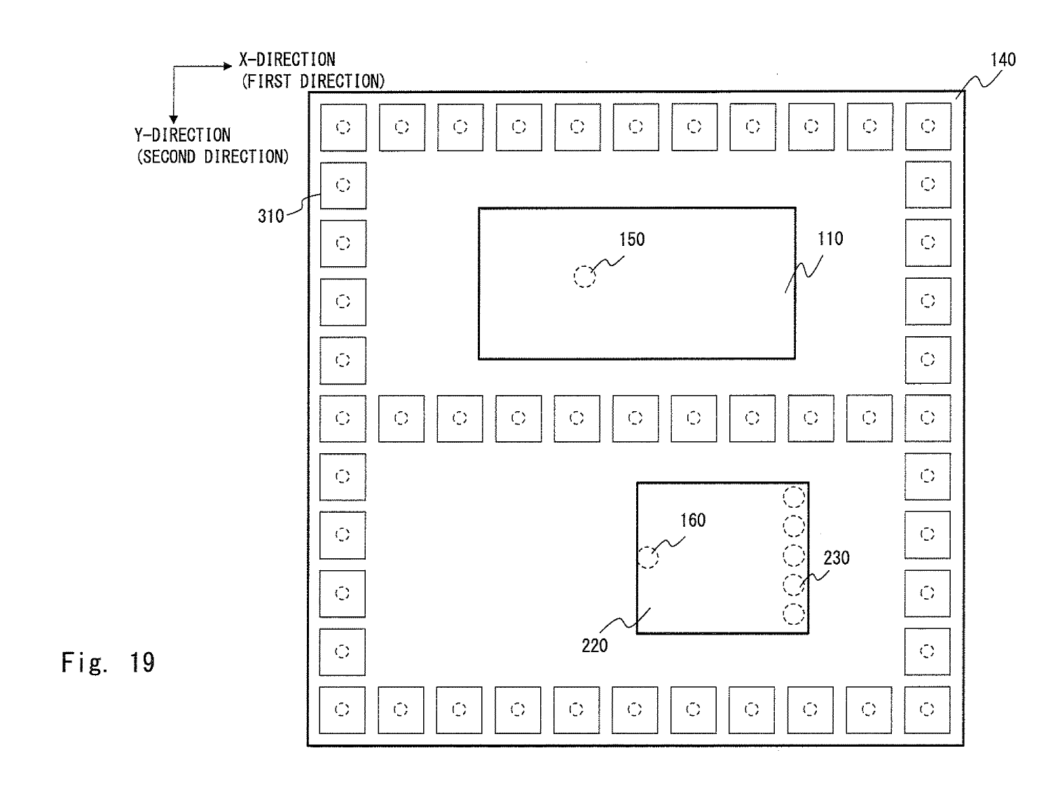

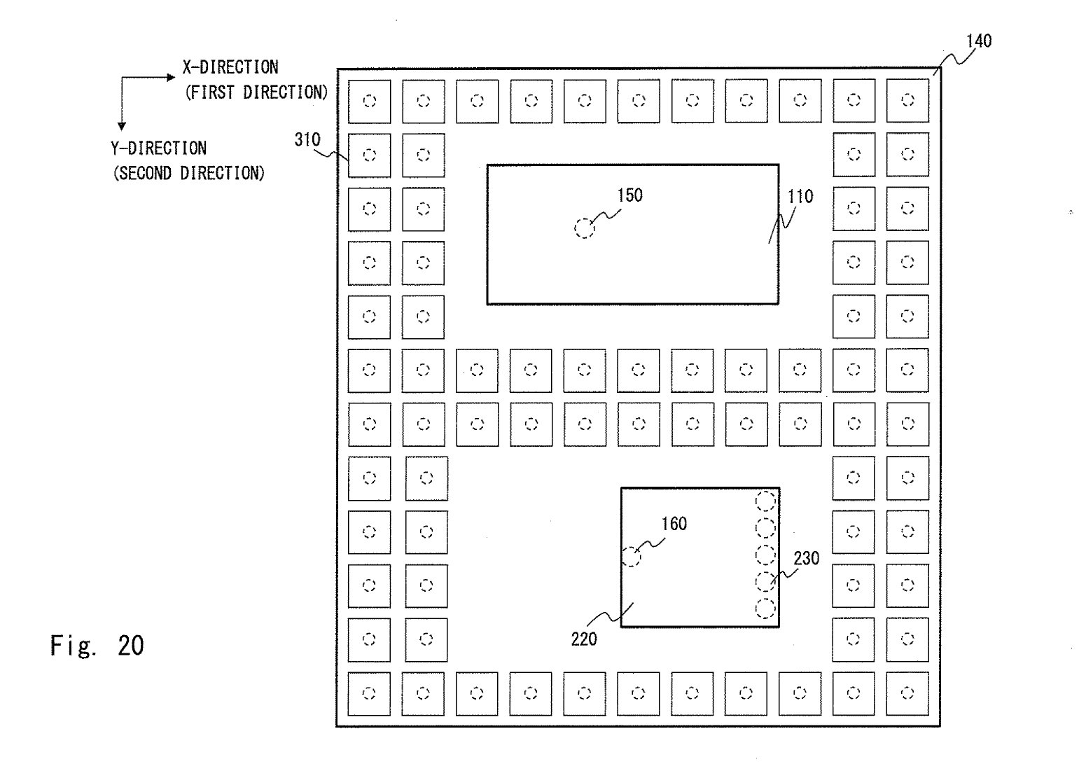

Further, as shown in FIG. 19, the electromagnetic wave restraint structures 310 may be disposed between the first and second conductor sections 110 and 220, so that the area around the first conductor section 110 may be separated from the area around the second conductor section 220. With this configuration, the impedance matching of the first and second conductor sections 110 and 220 can be independently performed.

Even in this case, a plurality of rows of electromagnetic wave restraint structures 310 may be disposed between the first and second conductor sections 110 and 220 as shown in FIG. 20. By arranging a plurality of electromagnetic wave restraint structures 310 between the first and second conductor sections 110 and 220, the area around the first conductor section 110 can be isolated from the area around the second conductor section 220 even further, thus making the adjustments of the impedance matching easier.

Note that the electromagnetic wave restraint structures arranged in the power receiving apparatus are not limited to the above-described mushroom-shaped EBG (Electromagnetic Band-Gap) structures each composed of a patch electrode and a conductor via. That is, various structures capable of a reducing electromagnetic wave leakage by reflecting the electromagnetic wave can be used.

As has been explained in each exemplary embodiment, a power receiving apparatus according to the present invention includes first and second conductor sections each of which receives an electromagnetic wave from an electromagnetic-wave propagation sheet, in which the first and second conductor sections are arranged so that when the received power of one of the conductor sections is close to the minimum value due to the influence by the standing wave, the received power of the standing wave received by the other conductor section is close to the maximum value. Therefore, it is possible to make the combined output obtained by combining the outputs from the first and second conductor sections uniform.

Note that although examples in which the interface apparatus is a power receiving apparatus are explained in each of the above-described exemplary embodiments, a power supplying apparatus can also be constructed by using a similar principle. In this case, the power receiving section in the power receiving apparatus is replaced by a power supplying section.

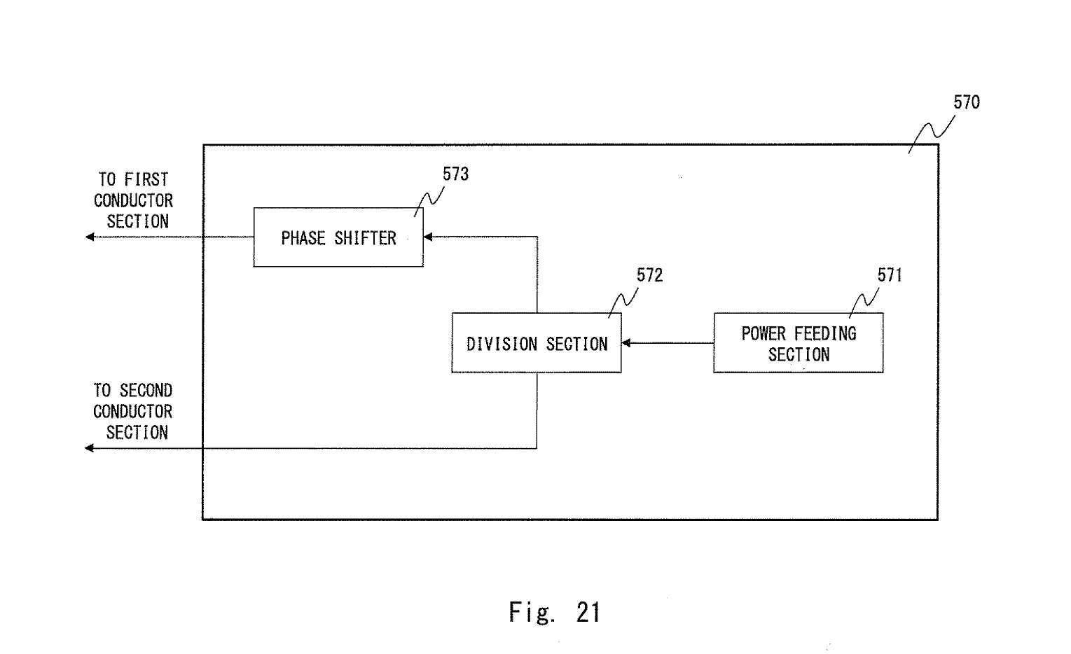

FIG. 21 is a block diagram showing an example of a configuration of a power supplying section 570 in this power supplying apparatus. The power supplying section 570 includes a power feeding section 571, a division section 572, and a phase shifter 573.

The power feeding section 571 generates high frequency power in an electromagnetic wave frequency band used for supplying electric power. The power feeding section 571 is connected to the division section 572 and the high frequency power generated by the power feeding section 571 is thereby output to the division section 572. The division section 572 divides the high frequency power input from the power feeding section 571 into parallel electric power outputs. Then, one of the parallel electric power outputs is output to the first path conductor section 150 through the phase shifter 573 and the other electric power output is supplied to the second path conductor section 160.

The phase shifter 573 adjusts the phase of the high frequency power input from the division section 572 and then outputs the phase-adjusted high frequency power to the first path conductor section 160.

With this configuration, the high frequency power generated by the power feeding section 571 disposed in the power supplying section 570 is supplied to both the first and second conductor sections 110 and 120, and electromagnetic waves each generated in a respective one of these conductor sections are fed to the communication sheet 10 through the meshed conductor section 13.

Note that when an electromagnetic wave is supplied to the communication sheet 10, the impedance is small in places corresponding to nodes of the standing wave. Therefore, the electromagnetic wave cannot be efficiently fed in those places. Even in this case, since the other conductor section is disposed in a place where the conductor section can efficiently feed the electromagnetic wave to the communication sheet 10, the electromagnetic wave can be efficiently fed to the communication sheet 10.

Therefore, it is possible to efficiently supply electric power from the power supplying section 570 to the communication sheet 10 irrespective of the position of the power supplying apparatus on the communication sheet 10.

Note that for the above-described power supplying apparatus, any of the configurations explained in the above-described exemplary embodiments can also be used for the configuration for the first and second conductor sections. Further, as explained above in the third exemplary embodiment, electromagnetic wave restraint structures are preferably arranged so as to surround the first and second conductor sections so that the leaking electromagnetic waves can be reduced.

Further, as the interface apparatus according to the present invention, a communication apparatus can also be constructed by using the above-explained principle. In this case, the power receiving section 170 in the power receiving apparatus is replaced by a communication section 670.

Further, the electromagnetic wave that propagates through the communication sheet 10 has been modulated as a carrier wave. Therefore, each of the first and second conductor sections obtains a modulated signal by receiving an electromagnetic wave propagating through the electromagnetic-wave propagation sheet. The modulated signals each obtained in a respective one of the first and second conductor sections are input to the communication section 670 through first and second path conductor sections, respectively.

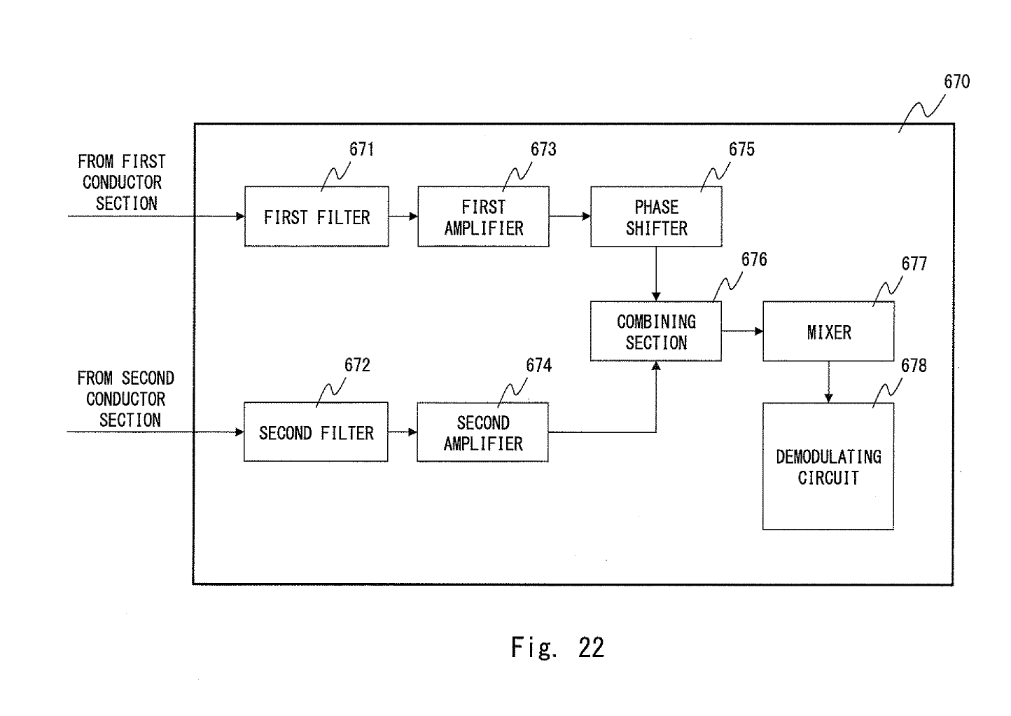

FIG. 22 is a block diagram showing an example of a configuration of the communication section 670. The communication section 670 includes a first filter 671, a second filter 672, a first amplifier 673, a second amplifier 674, a phase shifter 675, a combining section 676, a mixer 677, and a demodulating circuit 678.

The first filter 671 receives a received signal (modulated signal) that is received by the first conductor section 110 and sent through the first path conductor section 150, and lets a part of the received signal having a predetermined frequency band pass there through. Similarly, the second filter 672 receives a received signal that is received in the second conductor section 120 and sent through the second path conductor section 160, and lets a part of the received signal having a predetermined frequency band pass therethrough. Note that the first and second filters 671 and 672 have identical filtering characteristics.

The first amplifier 673 amplifies the received signal, which has passed through the first filter 671, with a predetermined amplification factor. Further, the second amplifier 674 amplifies the received signal, which has passed through the second filter 672, with a predetermined amplification factor.

The phase shifter 675 adjusts the phase of the received signal, which has been amplified by the first amplifier 673. The phase-adjusted received signal is output to the combining section 676.

The combining section 676 combines the received signal input from the phase shifter 675 with the received signal input from the second amplifier 674, and outputs the combined received signal to the mixer 677.

The mixer 677 mixes the combined received signal input from the combining section 676 with a local signal and thereby frequency-converts the combined received signal in an RF frequency band into a signal in an IF frequency band.

The demodulating circuit 678 demodulates the signal in the IF frequency band input from the mixer 677 and thereby takes out a transmission signal.

As described above, a communication apparatus according to the present invention includes: a first conductor section that obtains a modulated signal by receiving an electromagnetic wave propagating through the electromagnetic-wave propagation sheet; a second conductor section that obtains a modulated signal by receiving an electromagnetic wave propagating through the electromagnetic-wave propagation sheet; a ground conductor section disposed in an opposed state to the first and second conductor sections, the ground conductor section being connected to a ground potential; a combining section that combines the modulated signal obtained by the first conductor section with the modulated signal obtained by the second conductor section and thereby obtains a combined modulated signal, and a demodulation section that demodulates the combined modulated signal obtained by the combining section. Note that similarly to the above-described power receiving apparatus, the first and second conductor sections are arranged so that the interval between the open ends of each conductor section is no less than 2λ/14 and no greater than 5λ/14. In particular, the reception characteristic can be optimized when the first and second conductor sections are arranged so that the interval is λ/14.

As has been explained in each exemplary embodiment, an interface apparatus (power receiving apparatus, power supplying apparatus, or/and communication apparatus) according to the present invention has a relation that two conductor sections complement each other. Therefore, it is possible to receive electric power, supply electric power, or/and perform communication while reducing the positional selectivity.

Note that the above-described interface apparatus according to the present invention may be incorporated into a mobile information terminal device such as a laptop computer and a mobile phone, and used in that state. When such a mobile information terminal device is placed on a communication sheet 10 in a normal use state, it is placed on the communication sheet 10 so that its image display unit and/or keyboard face the user.

Note that the communication sheet 10 may be placed on a desk or the like, and the communication sheet 10 may be used so that an electromagnetic wave(s) is supplied from a power supplying apparatus attached at an end of the communication sheet 10 into the communication sheet 10. Therefore, the crosswise width direction of the mobile information terminal device coincides with the electromagnetic-wave traveling direction (x-direction) in a normal use state.

Therefore, the interface apparatus 20 is preferably placed in the mobile information terminal device so that the crosswise width direction of the mobile information terminal device coincides with the x-direction of the interface apparatus 20.

Note that the invention is not limited to the above-described exemplary embodiments and various changes may be made therein without departing from the spirit and scope of the present invention. For example, they can be described as the following supplementary notes.

(Supplementary Note 1)

A power receiving apparatus that receives electric power from a two-dimensionally spreading electromagnetic-wave propagation sheet, comprising:

a first conductor section that couples with an electromagnetic wave propagating through the electromagnetic-wave propagation sheet and thereby receives electric power;

a second conductor section that couples with an electromagnetic wave propagating through the electromagnetic-wave propagation sheet and thereby receives electric power;

a ground conductor section disposed in an opposed state to the first and second conductor sections, the ground conductor section being connected to a ground potential; and

a power combining section that combines electric power received from the first conductor section with electric power received by the second conductor section, wherein

the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

(Supplementary Note 2)

The power receiving apparatus described in Supplementary note 1, wherein the first and second conductor sections are arranged so that the interval in the first direction between one end of the first conductor section and one end of the second conductor section in the first direction is roughly equal to a quarter of the effective wavelength λ of the electromagnetic wave propagating through the electromagnetic-wave propagation sheet.

(Supplementary Note 3)

The power receiving apparatus described in Supplementary note 1 or 2, wherein each of the one ends of the first and second conductor sections is an open end.

(Supplementary Note 4)

The power receiving apparatus described in Supplementary note 3, wherein an end opposite to the one end of the second conductor section in the first direction is a short-circuited end short-circuited to the ground conductor section.

(Supplementary Note 5)

The power receiving apparatus described in Supplementary note 4, wherein both ends of the first conductor section in the first direction are open ends.

(Supplementary Note 6)

The power receiving apparatus described in Supplementary note 5, wherein

the first conductor section has a width in the first direction roughly equal to a half-wavelength of the effective wavelength λ of the electromagnetic wave propagating through the electromagnetic-wave propagation sheet,

the second conductor section has a width in the first direction roughly equal to a quarter of the effective wavelength λ of the electromagnetic wave propagating through the electromagnetic-wave propagation sheet,

the first and second conductor sections are arranged in a positional relation in which they are a predetermined distance away from each other in a second direction perpendicular to the first direction, and

the first and second conductor sections are arranged so that the interval between the one end of the first conductor section, which is an open end, and the one end of the second conductor section, which is an open end, in the first direction is no less than 2λ/14 and no greater than 5λ/14, where λ is the effective wavelength of the electromagnetic wave propagating through the electromagnetic-wave propagation sheet.

(Supplementary Note 7)

The power receiving apparatus described in Supplementary note 5, wherein

the first conductor section has a width in the first direction roughly equal to a half-wavelength of the effective wavelength λ of the electromagnetic wave propagating through the electromagnetic-wave propagation sheet,

the second conductor section has a width in the first direction roughly equal to a quarter of the effective wavelength λ of the electromagnetic wave propagating through the electromagnetic-wave propagation sheet,

the first and second conductor sections are arranged in a positional relation in which they are a predetermined distance away from each other in a second direction perpendicular to the first direction, and

the first and second conductor sections are arranged so that an open end of the second conductor section in the first direction is positioned at or near a center in a width direction of the first conductor section, the width direction being in the first direction.

(Supplementary Note 8)

The power receiving apparatus described in Supplementary note 3, wherein

each of the first and second conductor sections has a width in the first direction roughly equal to a half-wavelength of the effective wavelength λ of the electromagnetic wave propagating through the electromagnetic-wave propagation sheet,

the second conductor section is disposed in a place a predetermined distance away from the first conductor section in a second direction perpendicular to the first direction, and

the second conductor section is disposed so that the second conductor section is shifted from the first conductor section by a distance roughly equal to a quarter of the effective wavelength λ in the first direction.

(Supplementary Note 9)

The power receiving apparatus described in any one of Supplementary notes 1 to 8, further comprising:

a first path conductor section that connects the first conductor section with the power combining section; and

a second path conductor section that connects the second conductor section with the power combining section, wherein

the ground conductor section comprises through holes or notches through which the first and second path conductor sections pass in a noncontact state.

(Supplementary Note 10)

The power receiving apparatus described in any one of Supplementary notes 1 to 9, wherein

the power combining section comprises:
a first rectifying circuit that converts first AC power sent from the first conductor section into first DC power;
a second rectifying circuit that converts second AC power sent from the second conductor section into second DC power; and
a combining section that combines an output of the first rectifying circuit with an output of the second rectifying circuit, and

the power combining section thereby combines electric power outputs each received from a respective one of the first and second conductor sections.

(Supplementary Note 11)

The power receiving apparatus described in any one of Supplementary notes 1 to 9, wherein

the power combining section comprises:
a phase shifter that adjusts a phase of first AC power sent from the first conductor section;
a combining section that combines the first AC power, whose phase is adjusted by the phase shifter, with second AC power sent from the second conductor section to obtain third AC power; and
a rectifying circuit that rectifies the third AC power and thereby converts the third AC power into DC power, and

the power combining section thereby combines electric power outputs each received from a respective one of the first and second conductor sections.

(Supplementary Note 12)

The power receiving apparatus described in any one of Supplementary notes 1 to 11, wherein a plurality of electromagnetic wave restraint structures are arranged so as to surround the first and second conductor sections, the electromagnetic wave restraint structures being adapted to reflect an electromagnetic wave.

(Supplementary Note 13)

The power receiving apparatus described in Supplementary note 12, wherein a plurality of additional electromagnetic wave restraint structures are disposed between the first and second conductor sections, the electromagnetic wave restraint structures being adapted to reflect an electromagnetic wave.

(Supplementary Note 14)

The power receiving apparatus described in Supplementary note 11 or 12, wherein each of the electromagnetic wave restraint structures comprises:

an electromagnetic wave reduction conductor section disposed on the same plane as the first and second conductor sections; and

a connection conductor section that connects the electromagnetic wave reduction conductor section with the ground conductor section.

(Supplementary Note 15)

A power supplying apparatus that feeds electromagnetic wave to a two-dimensionally spreading electromagnetic-wave propagation sheet disposed near the power supplying apparatus, comprising:

a first conductor section that generates an electromagnetic wave and feeds the generated electromagnetic wave to the electromagnetic-wave propagation sheet;

a second conductor section that generates an electromagnetic wave and feeds the generated electromagnetic wave to the electromagnetic-wave propagation sheet;

a ground conductor section disposed in an opposed state to the first and second conductor sections, the ground conductor section being connected to a ground potential; and

a power supply section that supplies electric power used to generate the electromagnetic waves in the first and second conductor sections, wherein

the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave fed to the electromagnetic-wave propagation sheet, the effective wavelength being an effective wavelength within the electromagnetic-wave propagation sheet.

(Supplementary Note 16)

The power supplying apparatus described in Supplementary note 15, wherein the first and second conductor sections are arranged so that the interval in the first direction between one end of the first conductor section and one end of the second conductor section in the first direction is roughly equal to a quarter of the effective wavelength λ of the electromagnetic wave fed to the electromagnetic-wave propagation sheet, the effective wavelength λ being an effective wavelength within the electromagnetic-wave propagation sheet.

(Supplementary Note 17)

A communication apparatus that performs communication through a two-dimensionally spreading electromagnetic-wave propagation sheet, comprising:

a first conductor section that obtains a modulated signal by receiving an electromagnetic wave propagating through the electromagnetic-wave propagation sheet;

a second conductor section that obtains a modulated signal by receiving an electromagnetic wave propagating through the electromagnetic-wave propagation sheet;

a ground conductor section disposed in an opposed state to the first and second conductor sections, the ground conductor section being connected to a ground potential;

a combining section that combines the modulated signal obtained by the first conductor section with the modulated signal obtained by the second conductor section and thereby obtains a combined modulated signal, and

a demodulation section that demodulates the combined modulated signal obtained by the combining section, wherein

the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

(Supplementary Note 18)

The communication apparatus described in Supplementary note 17, wherein the first and second conductor sections are arranged so that the interval in the first direction between one end of the first conductor section and one end of the second conductor section in the first direction is roughly equal to a quarter of the effective wavelength λ of the electromagnetic wave propagating through the electromagnetic-wave propagation sheet.

(Supplementary Note 19)

A power receiving apparatus that receives electric power from a two-dimensionally spreading electromagnetic-wave propagation sheet, comprising:

a first conductor section that couples with an electromagnetic wave propagating through the electromagnetic-wave propagation sheet and thereby receives electric power;

a second conductor section that couples with an electromagnetic wave propagating through the electromagnetic-wave propagation sheet and thereby receives electric power;

a ground conductor section disposed in an opposed state to the first and second conductor sections, the ground conductor section being connected to a ground potential; and

a power combining section that combines electric power received from the first conductor section with electric power received by the second conductor section, wherein

the first and second conductor sections are arranged so as to satisfy a relation in which the electric field of the electromagnetic wave, which couples with the first conductor section, for the first conductor section has a roughly opposite phase to the phase of the electric field of the electromagnetic wave, which couples with the second conductor section, for the second conductor section in a state where the power receiving apparatus is placed on the electromagnetic-wave propagation sheet.

(Supplementary Note 20)

A power receiving apparatus that receives electric power from a two-dimensionally spreading electromagnetic-wave propagation sheet, comprising:

a first conductor section that couples with an electromagnetic wave propagating through the electromagnetic-wave propagation sheet and thereby receives electric power;

a second conductor section that couples with an electromagnetic wave propagating through the electromagnetic-wave propagation sheet and thereby receives electric power;

a ground conductor section disposed in an opposed state to the first and second conductor sections, the ground conductor section being connected to a ground potential; and

a power combining section that combines electric power received from the first conductor section with electric power received by the second conductor section, wherein

the first and second conductor sections are arranged so that when the power receiving apparatus is moved in an electromagnetic wave propagation direction in a state where the power receiving apparatus is placed on the electromagnetic-wave propagation sheet, a position where electric power received by the first conductor section is maximized roughly coincides with a position where electric power received in the second conductor section is minimized and a position where the electric power received by the first conductor section is minimized roughly coincides with a position where the electric power received in the second conductor section is maximized.

(Supplementary Note 21)

A power receiving apparatus that receives electric power from a two-dimensionally spreading electromagnetic-wave propagation sheet, comprising:

a first conductor section having a width in a first direction roughly equal to a half-wavelength of an effective wavelength λ of an electromagnetic wave propagating through the electromagnetic-wave propagation sheet;

a second conductor section having a width in the first direction roughly equal to the half-wavelength of the effective wavelength λ of the electromagnetic wave propagating through the electromagnetic-wave propagation sheet, the second conductor section being arranged with respect to the first conductor section in a second direction perpendicular to the first direction;

a ground conductor section disposed in an opposed state to the first and second conductor sections, the ground conductor section being connected to a ground potential; and

a power combining section that combines electric power received from the first conductor section with electric power received by the second conductor section, wherein

both ends of the first conductor section in the first direction are open ends, and both ends of the second conductor section in the first direction are short-circuited ends.

This application is based upon and claims the benefit of priority from Japanese patent application No. 2012-38181, filed on Feb. 24, 2012, the disclosure of which is incorporated herein in its entirety by reference.

### REFERENCE SIGNS LIST

10 COMMUNICATION SHEET (COMMUNICATION SHEET)
11 SHEET-LIKE CONDUCTOR SECTION
12 SHEET-LIKE DIELECTRIC SECTION
13 MESHED CONDUCTOR SECTION
14 INSULATOR SECTION
20 INTERFACE APPARATUS
100 POWER RECEIVING APPARATUS
110 FIRST CONDUCTOR SECTION
120 SECOND CONDUCTOR SECTION
130 THIRD CONDUCTOR SECTION (GROUND CONDUCTOR SECTION)
140 SUBSTRATE
150 FIRST PATH CONDUCTOR SECTION
160 SECOND PATH CONDUCTOR SECTION
170 POWER RECEIVING SECTION
171 PHASE SHIFTER
172 COUPLING SECTION
173 RECTIFIER CIRCUIT
174 FIRST RECTIFIER CIRCUIT
175 SECOND RECTIFIER CIRCUIT
176 COUPLING SECTION
200 POWER RECEIVING APPARATUS
220 SECOND CONDUCTOR SECTION
221 SECOND CONDUCTOR SECTION
230 CONDUCTOR VIA
300 POWER RECEIVING APPARATUS
310 ELECTROMAGNETIC WAVE REDUCTION STRUCTURE
311 PATCH ELECTRODE
312 CONDUCTOR VIA
570 POWER SUPPLYING SECTION
571 POWER FEEDING SECTION
572 DIVISION SECTION
573 PHASE SHIFTER
670 COMMUNICATION SECTION
671 FIRST FILTER
672 SECOND FILTER
673 FIRST AMPLIFIER
674 SECOND AMPLIFIER
675 PHASE SHIFTER
676 COMBINING SECTION
677 MIXER
678 DEMODULATING CIRCUIT

1. A power receiving apparatus that receives electric power from a two-dimensionally spreading electromagnetic-wave propagation sheet, comprising:
a first conductor section that couples with an electromagnetic wave propagating through the electromagnetic-wave propagation sheet and thereby receives electric power;
a second conductor section that couples with an electromagnetic wave propagating through the electromagnetic-wave propagation sheet and thereby receives electric power;
a ground conductor section disposed in an opposed state to the first and second conductor sections, the ground conductor section being connected to a ground potential; and
a power combining section that combines electric power received from the first conductor section with electric power received by the second conductor section, wherein
the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

2. The power receiving apparatus according to claim 1, wherein the first and second conductor sections are arranged so that the interval in the first direction between one end of the first conductor section and one end of the second conductor section in the first direction is roughly equal to a quarter of the effective wavelength λ of the electromagnetic wave propagating through the electromagnetic-wave propagation sheet.

3. The power receiving apparatus according to claim 1, wherein each of the one ends of the first and second conductor sections is an open end.

4. The power receiving apparatus according to claim 3, wherein an end opposite to the one end of the second conductor section in the first direction is a short-circuited end short-circuited to the ground conductor section.

5. The power receiving apparatus according to claim 4, wherein both ends of the first conductor section in the first direction are open ends.

6. The power receiving apparatus according to claim 5, wherein
the first conductor section has a width in the first direction roughly equal to a half-wavelength of the effective wavelength λ of the electromagnetic wave propagating through the electromagnetic-wave propagation sheet,
the second conductor section has a width in the first direction roughly equal to a quarter of the effective wavelength λ of the electromagnetic wave propagating through the electromagnetic-wave propagation sheet,
the first and second conductor sections are arranged in a positional relation in which they are a predetermined distance away from each other in a second direction perpendicular to the first direction, and
the first and second conductor sections are arranged so that the interval between the one end of the first conductor section, which is an open end, and the one end of the second conductor section, which is an open end, in the first direction is no less than 2λ/14 and no greater than 5λ/14, where λ is the effective wavelength of the electromagnetic wave propagating through the electromagnetic-wave propagation sheet.

7. The power receiving apparatus according to claim 5, wherein
the first conductor section has a width in the first direction roughly equal to a half-wavelength of the effective wavelength λ of the electromagnetic wave propagating through the electromagnetic-wave propagation sheet,
the second conductor section has a width in the first direction roughly equal to a quarter of the effective wavelength λ of the electromagnetic wave propagating through the electromagnetic-wave propagation sheet,
the first and second conductor sections are arranged in a positional relation in which they are a predetermined distance away from each other in a second direction perpendicular to the first direction, and
the first and second conductor sections are arranged so that an open end of the second conductor section in the first direction is positioned at or near a center in a width direction of the first conductor section, the width direction being in the first direction.

8. The power receiving apparatus according to claim 3, wherein
each of the first and second conductor sections has a width in the first direction roughly equal to a half-wavelength of the effective wavelength λ of the electromagnetic wave propagating through the electromagnetic-wave propagation sheet,
the second conductor section is disposed in a place a predetermined distance away from the first conductor section in a second direction perpendicular to the first direction, and
the second conductor section is disposed so that the second conductor section is shifted from the first conductor section by a distance roughly equal to a quarter of the effective wavelength λ in the first direction.

9. The power receiving apparatus described in claim 1, further comprising:
a first path conductor section that connects the first conductor section with the power combining section; and
a second path conductor section that connects the second conductor section with the power combining section, wherein
the ground conductor section comprises through holes or notches through which the first and second path conductor sections pass in a noncontact state.

10. The power receiving apparatus described in claim 1, wherein
the power combining section comprises:
a first rectifying circuit that converts first AC power sent from the first conductor section into first DC power;
a second rectifying circuit that converts second AC power sent from the second conductor section into second DC power; and
a combining section that combines an output of the first rectifying circuit with an output of the second rectifying circuit, and
the power combining section thereby combines electric power outputs each received from a respective one of the first and second conductor sections.

11. The power receiving apparatus described in claim 1, wherein
the power combining section comprises:
a phase shifter that adjusts a phase of first AC power sent from the first conductor section;
a combining section that combines the first AC power, whose phase is adjusted by the phase shifter, with second AC power sent from the second conductor section to obtain third AC power; and
a rectifying circuit that rectifies the third AC power and thereby converts the third AC power into DC power, and
the power combining section thereby combines electric power outputs each received from a respective one of the first and second conductor sections.

12. The power receiving apparatus described in claim 1, wherein a plurality of electromagnetic wave restraint structures are arranged so as to surround the first and second conductor sections, the electromagnetic wave restraint structures being adapted to reflect an electromagnetic wave.

13. The power receiving apparatus according to claim 12, wherein a plurality of additional electromagnetic wave restraint structures are disposed between the first and second conductor sections, the electromagnetic wave restraint structures being adapted to reflect an electromagnetic wave.

14. The power receiving apparatus according to claim 12, wherein each of the electromagnetic wave restraint structures comprises:
an electromagnetic wave reduction conductor section disposed on the same plane as the first and second conductor sections; and
a connection conductor section that connects the electromagnetic wave reduction conductor section with the ground conductor section.

15. A power supplying apparatus that feeds electromagnetic wave to a two-dimensionally spreading electromagnetic-wave propagation sheet disposed near the power supplying apparatus, comprising:
a first conductor section that generates an electromagnetic wave and feeds the generated electromagnetic wave to the electromagnetic-wave propagation sheet;
a second conductor section that generates an electromagnetic wave and feeds the generated electromagnetic wave to the electromagnetic-wave propagation sheet;
a ground conductor section disposed in an opposed state to the first and second conductor sections, the ground conductor section being connected to a ground potential; and
a power supply section that supplies electric power used to generate the electromagnetic waves in the first and second conductor sections, wherein
the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave fed to the electromagnetic-wave propagation sheet, the effective wavelength being an effective wavelength within the electromagnetic-wave propagation sheet.

16. The power supplying apparatus according to claim 15, wherein the first and second conductor sections are arranged so that the interval in the first direction between one end of the first conductor section and one end of the second conductor section in the first direction is roughly equal to a quarter of the effective wavelength λ of the electromagnetic wave fed to the electromagnetic-wave propagation sheet, the effective wavelength λ being an effective wavelength within the electromagnetic-wave propagation sheet.

17. A communication apparatus that performs communication through a two-dimensionally spreading electromagnetic-wave propagation sheet, comprising:
a first conductor section that obtains a modulated signal by receiving an electromagnetic wave propagating through the electromagnetic-wave propagation sheet;
a second conductor section that obtains a modulated signal by receiving an electromagnetic wave propagating through the electromagnetic-wave propagation sheet;
a ground conductor section disposed in an opposed state to the first and second conductor sections, the ground conductor section being connected to a ground potential;
a combining section that combines the modulated signal obtained by the first conductor section with the modulated signal obtained by the second conductor section and thereby obtains a combined modulated signal, and
a demodulation section that demodulates the combined modulated signal obtained by the combining section, wherein
the first and second conductor sections are arranged so that an interval in a first direction between one end of the first conductor section and one end of the second conductor section in the first direction is no less than 2λ/14 and no greater than 5λ/14, where λ is an effective wavelength of the electromagnetic wave propagating through the electromagnetic-wave propagation sheet.

18. The communication apparatus according to claim 17, wherein the first and second conductor sections are arranged so that the interval in the first direction between one end of the first conductor section and one end of the second conductor section in the first direction is roughly equal to a quarter of the effective wavelength λ of the electromagnetic wave propagating through the electromagnetic-wave propagation sheet.
